(19) United States
(12) Patent Application Publication
(10) Pub. No.: US 2014/0334878 A1
(43) Pub. Date: Nov. 13, 2014

(54) OFFSET TRENCHING METHODS AND APPARATUS, AND VOID RESTORATION METHODS, APPARATUS AND MATERIALS IN CONNECTION WITH SAME

(71) Applicant: CertusView Technologies, LLC, Palm Beach Gardens, FL (US)

(72) Inventor: Daniel Paul Miller, Brush Prairie, WA (US)

(73) Assignee: CertusView Technologies, LLC, Palm Beach Gardens, FL (US)

(21) Appl. No.: 14/204,462

(22) Filed: Mar. 11, 2014

Related U.S. Application Data
(60) Provisional application No. 61/785,609, filed on Mar. 14, 2013.
(60) Provisional application No. 61/800,554, filed on Mar. 15, 2013.

(51) Int. Cl. F16L 1/032

(52) U.S. Cl. CPC F16L 1/032
USPC 405/154.1

(57) ABSTRACT

Methods and apparatus for forming a trench alongside a vehicle (for burying fiber optic cables, electrical conductors, and conduits). A cutting blade is coupled to the vehicle via an offset arm. As the vehicle is advanced along a road, the cutting blade is laterally offset from the vehicle and positioned so as to cut a narrow (e.g., 0.5-1.5 inches) and deep (e.g., 10-12 inches) trench alongside the vehicle (e.g., at the inner face of the street curb between the curb and a sidewalk abutting the curb). The offset arm includes one or more mechanical joints to facilitate adjustment of one or more of a lateral offset distance between the vehicle and the blade, a vertical offset distance between a blade housing and a road surface, and rotation of the blade housing around at least two axes to facilitate appropriate positioning of the cutting blade with respect to the vehicle.

### CROSS-REFERENCES TO RELATED APPLICATIONS

The present application claims a priority benefit, under 35 U.S.C. §119(e), to U.S. provisional application Ser. No. 61/785,609, filed Mar. 14, 2013, entitled “Offset Trenching Methods and Apparatus, and Void Restoration Methods, Apparatus and Materials in Connection with Same.” The present application also claims a priority benefit, under 35 U.S.C. §119(e), to U.S. provisional application Ser. No. 61/800,554, filed Mar. 15, 2013, entitled “Offset Trenching Methods and Apparatus, and Void Restoration Methods, Apparatus and Materials in Connection with Same.” Each of the foregoing applications is hereby incorporated by reference herein in its entirety.

### BACKGROUND

Traditional methods of forming a trench into a road surface include using, for example, a blade housing having a rotating blade that can cut into the top surface of the road. The blade housing is mounted on the rear of a vehicle (e.g., a tractor), and is pulled by the vehicle on the road while the blade cuts through the road surface. This leaves a trench in the road surface having a width that is approximately equal to the width of the blade. The vehicle pulling the blade housing defines a footprint on the road surface (i.e., essentially the width of the vehicle as the vehicle traverses along the road surface). As the blade housing is pulled behind the vehicle within the vehicle's footprint, the trench is also formed within the footprint. Furthermore, the trench is formed into the same road surface on which the vehicle is driven. In other words, the location where the trench is to be formed needs to provide a drivable path at least as wide as the footprint of the vehicle, so that the vehicle can effectively pull the blade housing along the road surface immediately behind the vehicle. Some examples of traditional trenching systems include MT12® Microtrencher commercially available from DITCHWITCH®, and MTR12® and MTR16® trenchers commercially available from VERMEER®.

### SUMMARY

The systems, methods and devices of the disclosure each have several innovative aspects, no single one of which is solely responsible for the desirable attributes disclosed herein.

Various embodiments of the present invention are directed to methods and apparatus for “offset trenching.” In the various exemplary embodiments discussed herein, “offset trenching” refers generally to forming a trench in a ground surface (e.g., in a road surface, or proximate to a road surface, such as adjacent to a street curb or sidewalk) using a cutting blade coupled to a vehicle, in which the trench is formed outside of the footprint of the vehicle (e.g., off to one side of the vehicle as the vehicle is advanced along a road). In some embodiments, a trench is thusly formed along an inner face of a street curb or in a sidewalk adjacent to a road surface. In some applications, such a trench is made to bury fiber optic cables, electrical conductors (e.g., electrical cables or telecommunication wires), and/or conduits.

In one embodiment, a cutting blade is coupled to a vehicle via an offset arm. As the vehicle is advanced along the road (e.g., in a direction parallel to the street curb or a sidewalk flanking the road), the cutting blade is laterally offset from the vehicle and positioned so as to cut a narrow (e.g., 0.5-1.5 inches) and deep (e.g., 10-12 inches) trench (e.g., along an inner face of the street curb between the curb and a sidewalk abutting the curb). The offset arm includes one or more mechanical joints to facilitate adjustment of one or more of: a lateral offset distance between the vehicle and the blade; a vertical offset distance between a blade housing and a road surface; and rotation of the blade housing around at least two axes, so as to facilitate appropriate positioning of the cutting blade with respect to the vehicle and/or the surface into which the trench is cut.

In sum, one innovative aspect of the subject matter described in this disclosure is implemented in an apparatus comprising a vehicle for driving on a road, the vehicle having a footprint on a road surface of the road when driven on the road. The apparatus further comprises a blade mechanically coupled to the vehicle such that the blade plane is laterally offset from and is outside the footprint of the vehicle when the vehicle is driven on the road.

Another innovative aspect of the subject matter described in this disclosure is implemented in an apparatus comprising an offset arm for mechanically coupling a cutting blade to a vehicle. The offset arm includes a coupling mechanism to couple the offset arm to one of a front side, a rear side, and a lateral side of the vehicle. The offset arm is configured such that the blade is laterally offset from and is outside of a footprint of the vehicle when the vehicle is driven on the road. The offset arm further includes one or more mechanical joints to facilitate adjustment of one or more of a lateral offset distance between the vehicle and the blade, a vertical offset distance between the blade and a road surface, and rotation of the blade around at least two axes, so as to facilitate appropriate positioning of the cutting blade with respect to the vehicle. In one inventive embodiment, the blade is included within a blade housing that is mounted to the offset arm. Another inventive embodiment is directed to the combination of the vehicle, the offset arm coupled to the vehicle, and the blade housing including the blade and coupled to the offset arm.

Another innovative aspect of the subject matter described in this disclosure is implemented in a method comprising forming a trench along an inner face of a street curb, wherein the street curb has an exposed top face, a buried bottom face, and a partially exposed outer face adjacent to and abutting a road surface. At least a portion of the inner face of the street curb, prior to forming the trench, is adjacent to and abuts the sidewalk material. The trench is formed along the inner face of the street curb such that the trench includes a first vertical sidewall substantially constituted by the inner face of the street curb and a second vertical sidewall constituted at least in part by the sidewalk material.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 shows an example worksite for constructing a cable installation.

FIG. 2A shows a cross-sectional view of a curb and a sidewalk before the construction of the cable installation.

FIG. 2B shows a cross-sectional view of a monolithic curb and sidewalk before the construction of the cable installation.

FIG. 3 shows a cross-sectional view of the example worksite after the construction of the cable installation.

FIG. 4 shows a rear view of an example cutting machine for cutting a trench in a sidewalk.

FIGS. 5A-5D show top views of various examples of a cutting machine.

FIG. 6 shows a cross sectional view of an example offset arm of the cutting machine.

FIG. 7 shows an example curved offset arm.

FIGS. 8A-8D show various views of an example cutting machine having an offset arm attached to the front of the machine.

FIG. 9A-9D show various views of an example cutting machine having an offset arm attached to the rear of the machine.

FIGS. 10A-10D show various views of an example cutting machine having an offset arm attached to the side of the machine.

The features and advantages of the present invention will become more apparent from the detailed description set forth below when taken in conjunction with the drawings.

### DETAILED DESCRIPTION

Following below are more detailed descriptions of various concepts related to, and embodiments of, inventive systems, methods, materials and apparatus for offset trenching and void restoration. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Formation of a Cable Installation

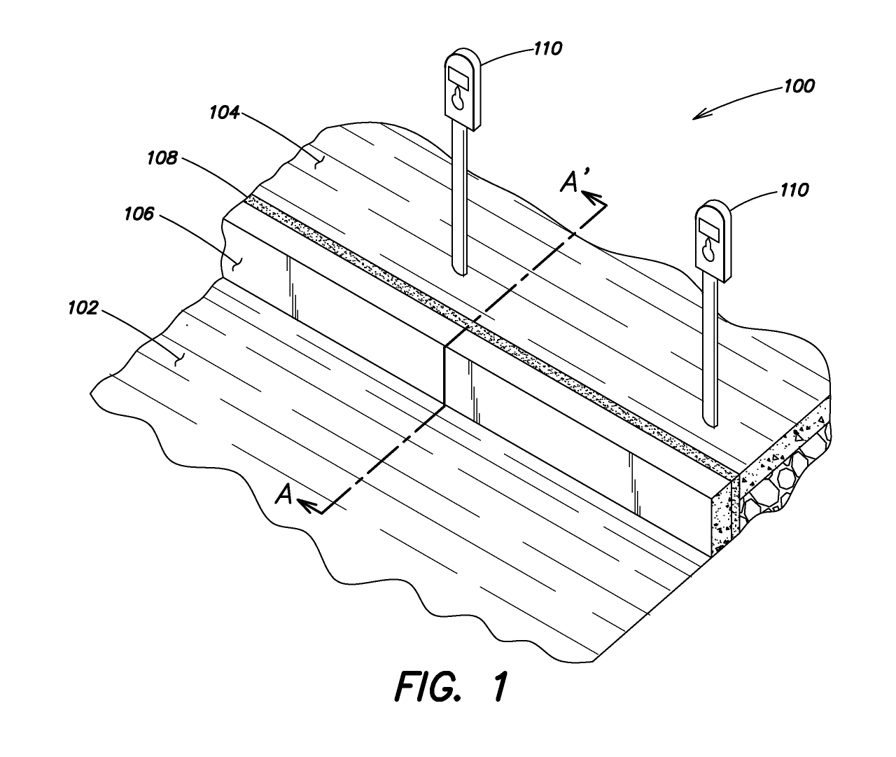

FIG. 1 shows a perspective view of a work site 100 at which a trench is to be formed, according to one embodiment of the present invention. In this embodiment, the trench is formed to facilitate laying (burying) of utility infrastructure, such as fiber optic cable, electrical conductors (e.g., power cables, telecommunications wire cables), or conduit, for example (hereafter, referred to simply as “cables”). The work site 100 includes a road 102 adjacent to an elevated sidewalk 104. A curb 106 is situated in between the road 102 and the sidewalk 104. A cable installation 108 is constructed in a region between the sidewalk 104 and the curb 106. FIG. 1 shows only a top surface of a backfilled cable installation 108 that includes a trench, at the bottom of which communication cables are laid.

Generally, the road 102 can be any surface that provides for movement of foot or vehicular traffic. For example, the road 102 could be, but is not limited to, pavement, paving, concrete, asphalt, blacktop, cobblestone, brick, or other road base, grade or surface, or the like, or any combination of the foregoing. The sidewalk 104, as mentioned above, is elevated with respect to the surface of the road 102. The elevation could be, but is not limited to, about 4-12 inches. In some instances, the sidewalk 104, similar to the road 102, can also be used for providing a surface for foot or some vehicular traffic. As such, the sidewalk 104 could be, but not limited to, pavement, paving, concrete, asphalt, blacktop, cobblestone, brick, aggregate (crushed rock and concrete), manufactured pavers, or other road base, grade or surface, or the like, or any combination of the foregoing. In some other examples, the sidewalk 104 may be a road median or a road shoulder.

In some environments, such as urban zones, various objects such as fire hydrants, parking meters, road signs, bus-stops, street lights, etc., may be installed on the surface of the sidewalk 104. Typically, these objects are installed only a few inches from the edge of the curb 106. For example, FIG. 1 shows two parking meters 110 installed on the sidewalk 104 a few inches from the edge of the sidewalk 104 that is proximal to the road 102.

As mentioned above, the curb 106 is constructed between the road 102 and the sidewalk 104. The curb 106 not only provides structural stability to the sidewalk 104 but also protects the sidewalk 104 from being damaged by incidental contact with vehicles driving on the road 102. The curb 106 can be constructed from materials such as stone or masonry blocks, cement, aggregate, cobblestone, manufactured pavers, asphalt, etc.

In one embodiment, the cable installation 108 is constructed between the curb sidewalk 104 and the curb 106. As mentioned above, the cable installation 108 includes a trench (or void, or narrow channel), at the bottom of which communication cables are laid. The trench is then backfilled with filling material such that the top of the cable installation 108 is at substantially the same horizontal level as the sidewalk 104.

Traditional methods of excavating a trench into a road surface, for example, include using a blade housing having a rotating blade that can cut into the top surface of the road. The blade housing is pulled by a vehicle on the road while the blade cuts through the surface of the road. This leaves a trench in the road surface having a width that is approximately equal to the width of the blade. The trench, however, is formed within the footprint of the vehicle pulling the blade housing.

The inventor has appreciated that this conventional method of forming a trench is difficult, or in some situations even impossible to carry out, if the surface in which the trench is to be cut is at a different elevation than the road surface, and/or outside of the footprint of the vehicle, e.g., at an inner face of a curb adjacent to and abutting a sidewalk, such as the sidewalk 104 of FIG. 1. For one, the sidewalk 104 is at an elevation, while the blade in the traditional method is configured to cut into surfaces that are at the same level as the road over which the pulling vehicle is driven. Furthermore, because of the various installations such as fire hydrants, parking meters, etc. near the curb, the vehicle for pulling the blade housing cannot be driven near the curb on the sidewalk 104. The vehicle would either have to be driven over the road adjacent to the sidewalk or, if space is available, further away from the curb over the sidewalk. This means that the curb would be outside the footprint of the pulling vehicle. However, because in conventional approaches the blade housing cuts the trench only within the footprint of the vehicle pulling the blade housing, the blade cannot be appropriately positioned to cut a trench near the curb, as desired.

In some implementations, it may be desired that the cable installation, as shown in FIG. 1, be located on the road 102 instead of being located at an elevation on the sidewalk 104. The cable installation may, however, be outside of the footprint of the pulling vehicle. For example, it may be desired that the cable installation be located on the road 102 and in close proximity (2-4 inches) to the curb 106. In some other implementations, it may be desired that the cable installation be located on the road 102 but close to objects such as sign-posts, parking meters, and other hazards. In such implementations, the proximity of the cable installation to the hazards means that a blade housing surrounding the blade needs to be within a certain distance from the blade so as to avoid coming in contact with objects on the road while the blade is cutting into the road. As discussed further below, in some exemplary implementations an outer surface of the blade housing is configured such that it does not extend more than approximately 2-4 inches from the plane of the blade (or from the desired location of the cable installation).

The following discussion presents details of the cable installation 108 both near the curb 106 and over the road 102 and the machines utilized to construct it, according to various embodiments of the present invention.

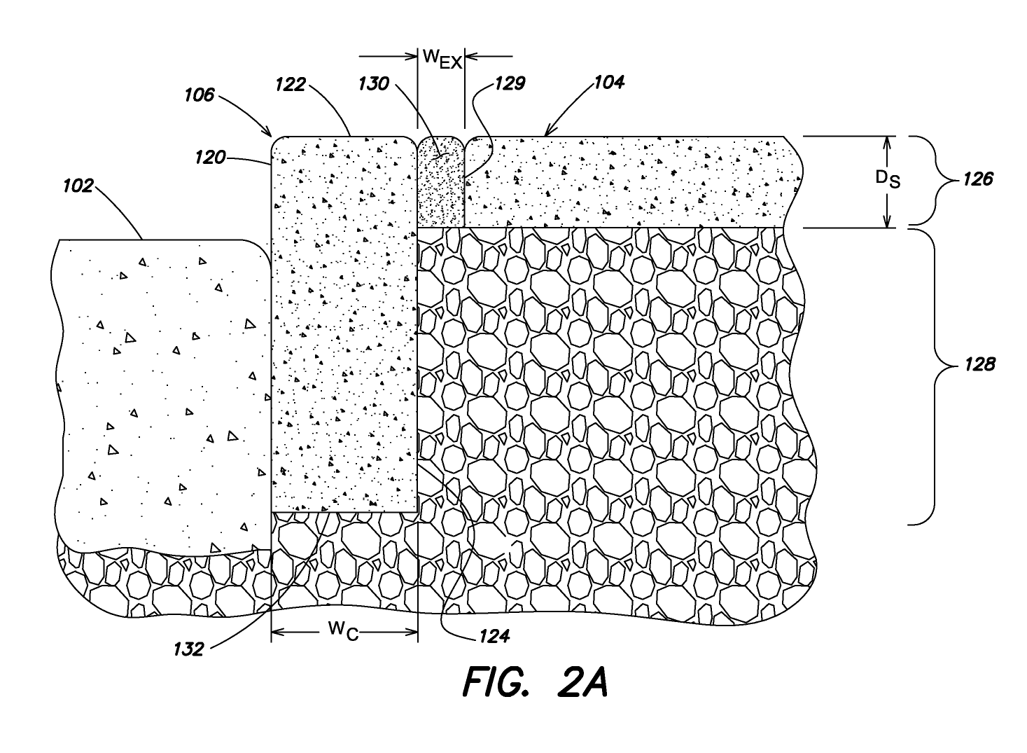

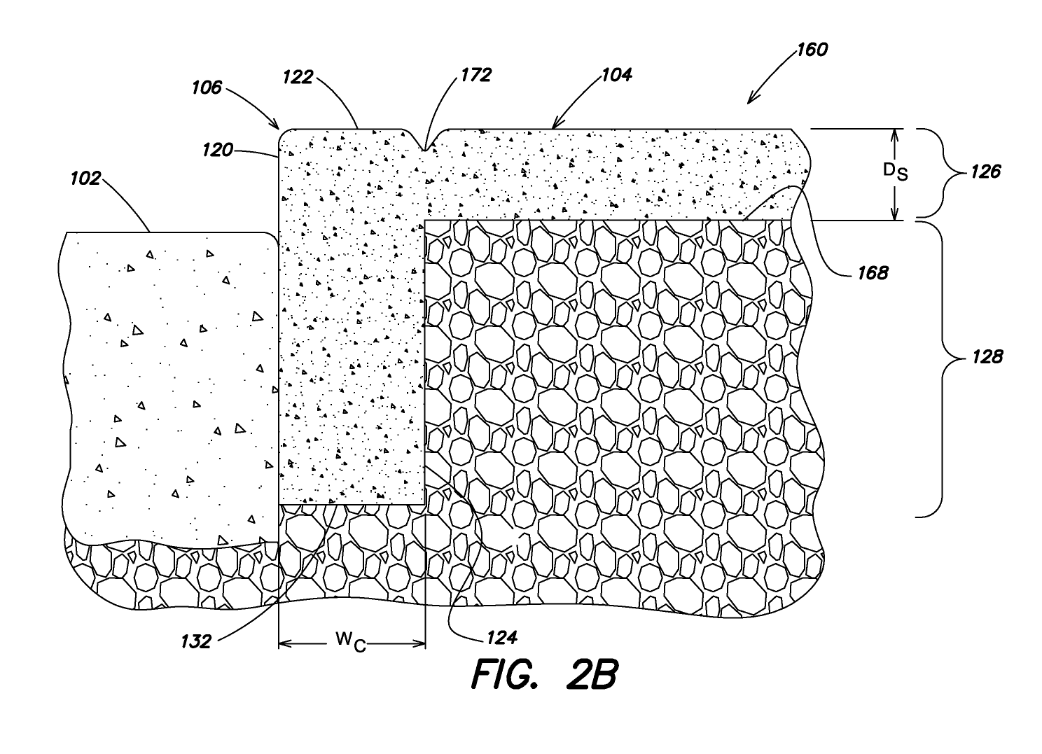

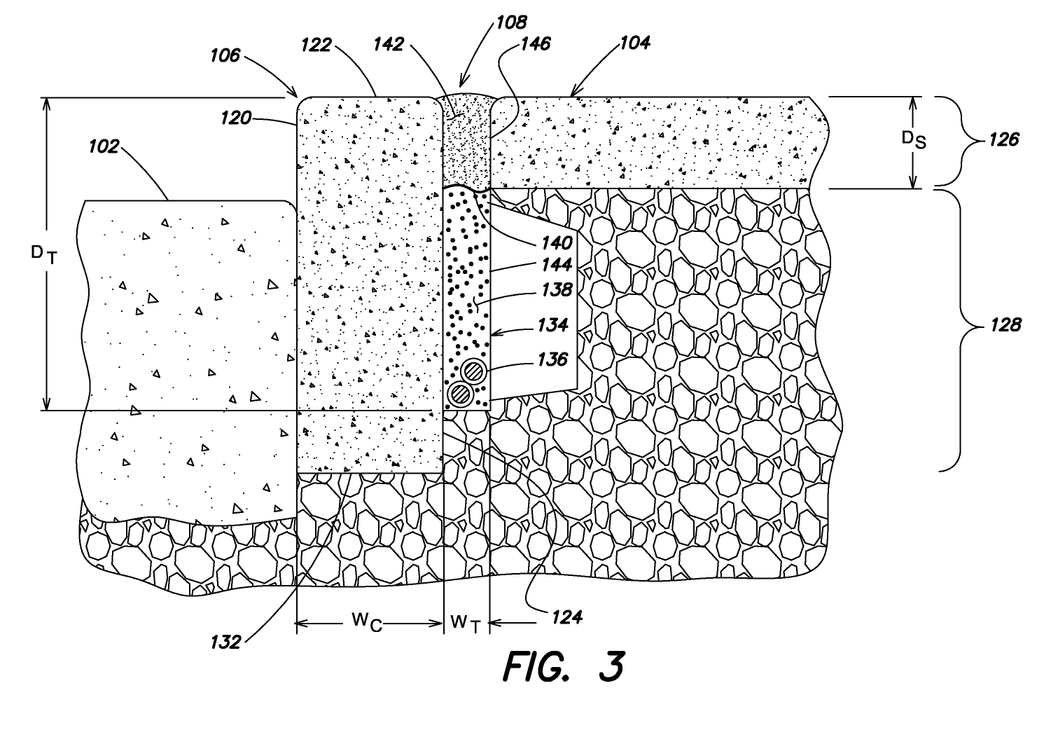

FIGS. 2A-3 show cross-sectional views of the worksite 100 before and after the construction of the cable installation 108 shown in the embodiment of FIG. 1. FIG. 2A shows the curb 106 having a substantially rectangular cross section. The curb 106 includes a first substantially vertical surface 120 to which the road 102 abuts. A bottom edge of first vertical surface 120 generally extends below the surface of the road 102. In some implementations, the first vertical surface 120 may extend up to about 12-18 inches below the surface of the road 102 and up to about 6-12 inches above the road 102. A top edge of the first vertical surface 120 is configured to be at approximately the same elevation as that of the sidewalk 104. A top horizontal surface 122 extends horizontally from the top edge of the first vertical surface 108 to a top edge of a second substantially vertical surface (also referred to as “inner surface”) 124. The top horizontal surface 122 of the curb generally defines the width W_{C} of the curb. In some implementations, the width W_{C} of the curb can be up to about 6 inches to about 8 inches. The inner surface 124 rests against the vertical surfaces of the sidewall 104. Finally, the curb 106 can also include a bottom horizontal surface 132 that extends from the bottom edge of the first vertical surface 120 to the bottom edge of the inner surface 124.

The sidewall 104 can include a top sidewalk section 126 and a bottom sidewalk section 128. The top sidewalk section 116 is usually constructed out from concrete, but other materials discussed above in relation to FIG. 1 can also be used. The top sidewalk section 126 can have a depth D_{S} of about 4 inches to about 6 inches. In some implementations, a vertical surface 129 of the top sidewalk section 126 can abut or touch the inner surface 124. In some other implementations, an expansion joint 130 may be included between the vertical surface 129 and the inner surface 124 of the curb 106. The expansion joint 130 safely absorbs heat-induced expansion and contraction of the upper sidewalk section 126, and can be constructed using materials that are generally compressible. For example, materials such as wood or plastic can be used. The width W_{EX} of the expansion joint 130 can be function of the extent to which the material used for constructing the top sidewalk section 126 expands or contracts. In some implementations, the width W_{ES} may be between 1-2 inches. The bottom sidewalk section 128 can be a native backfill material, and may include the same ground material over which the road 102 is constructed.

In some implementations, the curb 106 and the sidewalk 104 may be laid using the same material forming a monolithic curb-sidewalk 160, as shown in FIG. 2B. In a monolithic curb-sidewalk 160, the curb 106 and the sidewalk 104 are not separated by an expansion joint, such as the expansion joint 130 discussed above in relation to FIG. 2A. Similar to the curb 106 shown in FIG. 2A, the monolithic curb 106 shown in FIG. 2B includes a first vertical surface 120 adjacent to the road 102 and a bottom horizontal surface 132 that extends from a bottom edge of the first vertical surface 120. The bottom horizontal surface 132 can define the width W_{C} of the monolithic curb 106. However, unlike the inner surface 124 of the curb 106 of FIG. 2A, which vertically extends from the bottom surface 132 to the upper horizontal surface 122, the inner surface 124 of the monolithic curb 106 extends only up the sidewalk section 126. The sidewalk section can have a thickness of D_{S} inches. On the surface, the curb 106 and the sidewalk 104 can be separated by a surface groove 172. Thus, the top horizontal surface 122 of the curb can extend from the top edge of the first vertical surface 120 up to the surface groove 172. Similarly the top surface of the sidewalk 104 can extend up to the surface groove 172. In some implementations, the surface groove 172 may be aligned with the inner surface 124 of the curb 106.

FIG. 3 shows a cross sectional view of the worksite 100 after the construction of the cable installation 108, according to one embodiment. The cable installation 108 includes a substantially vertical trench 134 that is cut in a region adjacent to the inner surface 124 of the curb 106 shown in FIG. 2A. While the construction of the cable installation 108 is explained below with reference to FIG. 2A, it is understood that the cable installation 108 can be similarly carried out for the monolithic curb-sidewalk 160 discussed above in relation to FIG. 2B. For example, a trench similar to the trench 134 may be cut into the surface groove 172 on the surface of the monolithic curb-sidewalk shown in FIG. 2B. The trench 134 is evacuated of any debris, after which cables 136 are laid. After laying the cables 136, the trench is filled with a filling material to protect the cables 136 and to fill the trench 134. In some implementations, a portion of the trench 134 may be filled back with the debris collected from the cutting process. In some other implementations, the trench 134 can be filled with native spoils, non-native sand, gravel, etc. In some other implementations, the trench 134 can be filled with a non-shrinking and flowable filling material 138 to protect the cables 136. The filling material 138 hardens after a drying period. In some implementations, the filling material is filled up to the top of the trench 134. In some other implementations, the filling material is filled only up to the depth D_{S} of the top sidewall section 126. The remaining portion of the trench 134 is filled with a topping material 142 that is compressible, and may have properties similar to the expansion joint 130 discussed above in relation to FIG. 2A. Thus, the trench 134 may have a bottom section 144, which is filled with a non-compressible filling material 138, and a top section 146, which is filled with the topping material 142.

As mentioned above, in one embodiment the trench 134 may be formed adjacent to the inner surface 124 of the curb 106. The trench 134 can be formed by lowering a rotating circular cutting blade in a region of the sidewalk 104 adjacent to the inner surface 124 of the curb 106. Various embodiments of a cutting blade employed for forming the trench 134 and the associated machinery is described further below in detail. The cutting blade is lowered until a desired depth D_{T} of the trench is achieved. In some implementations, the depth D_{T} can be measured from the top horizontal surface 122 of the curb 106. In some other implementations, the depth D_{T} can be measured from the top surface of the sidewalk 104. In some implementations, the depth D_{T} is selected to be between 4 to 12 inches. In some other implementations, the depth D_{T} is selected to be between 5 to 15 inches. Having a depth of no more than 12 to 15 inches can avoid penetration of existing utility lines within the sidewalk 104, and thereby may speed up the permitting process required to construct at the work site. Furthermore, excessive depth of the channel may inhibit effective evacuation of the leftover debris and cuttings. Nonetheless, the depth of the trench 134 is not limited to 12 to 15 inches.

The trench 134 is formed with a width W_{T} that is sufficient to accommodate the cables 136. In some implementations, the width W_{T} can be between about 0.5 inches to about 1.5 inches. In some other implementations, the width W_{T} can be between about 0.68 inches to about 1.25 inches. Selecting the width W_{T} can also be based on the economics of the amount of filling material 138 (and perhaps the topping material 142) that may be required to completely fill the trench 134. That is, the volume of filling material required to fill the trench 134 may increase with the increase with the width W_{T}, increasing overall cost. In some implementations, the width W_{T} of the trench 134 may be a function, in part, of the thickness of the blade used for cutting the trench 134. In some implementations, the width W_{T} of the trench 134 may be greater than the width of the blade. In some implementations, the width W_{T} of the trench 134 may be non-uniform along the length of the trench 134. In some instances, the width W_{T} of the trench may be non-uniform along the height of the trench 134. This non-uniformity may be caused due to voids created by dislodged rocks, stones, or other material in the trench's sidewalls.

It should be noted that if the width W_{T} is less than the with W_{EX} of the expansion joint 130, then one or both sidewalls of the top section 144 may be formed by the expansion joint 130 material. Furthermore, the bottom section 144 may be formed a small distance away from the inner surface 124 of the curb 106 such that one or both sidewalls of the bottom section 144 of the trench 134 may be formed by the uncut backfill material of the bottom sidewalk portion 128. Thus, even though the trench 134 is formed adjacent to (or in abutment with) the curb 106, it may not necessarily touch the inner surface 124 of the curb 106. In some implementations, such as when the curb 106 is constructed with a shallow angle (i.e., is not vertical), the trench 134 may be formed by the blade partly cutting into the inner surface 124 of the curb 106. In such implementations, a portion of the bottom surface of the trench 134 may include the curb 106 material. In some other implementations, the tilt of the blade may be adjusted such that an angle of tilt of the blade is similar to the shallow angle of the inner surface 124 of the curb 106 so that the blade is prevented from cutting into the inner surface 124.

After the trench 134 is formed, it is evacuated of any cuttings and debris. The evacuation, as described further below, can be carried out using a vacuuming system that operates simultaneously with the operation of the cutting blade. In this manner, a stream of cuttings and debris produced by the cutting blade is immediately evacuated by the vacuuming system.

The cables 136 can be laid into a length of the trench that has been evacuated. The cables 136 can be laid manually or using a cable laying machine. In some implementations, more than two cables 136 can be laid into the trench 134. In some other implementations, a conduit may be laid into the trench 134, which conduit may include one or more cables. In some other implementations, the conduit may include no cables, which may be pulled into the conduit at a future point in time. The cables 136 can include, without limitation, fiber optic cables, electrical cables, wire cables, communication cables, etc.

After the cables 136 have been laid, the filling material 138 is poured or pumped into the trench 134. In some implementations, the filling material 138 can be poured manually into the trench 134. In some other implementations, a pump or a machine may be used to pump the filing material 138 from a reservoir into the trench 134 via a pipe or a duct. As mentioned above, the filling material 138 is preferably flowable and non-shrinking. Being flowable allows the filling material 138 to fill the bottom section 144 of the trench 134 and bonds or encases the cables 136. The filling material 138 can include, without limitation, materials such as, plaster, grout or mortar. In some implementations, grout can be used as the filling material 138. The grout can be flowed into the trench 134 using a hand-held duct coupled to a grout pump.

In some implementations, the filling material 138 can be viscid, sticky, and have a fluid consistency. In addition, the filling material 138 can have a certain viscosity that allows it to flow into the trench 134 and substantially surround the cables 136. The filling material 138 can also flow into voids in the sidewall of the trench 134 left behind by dislodged rocks or stones. Due to the flowability of the filling material 138, formation of air bubbles or spaces within the filled bottom section 144 and at the interface 140 with the topping material 142, can be reduced or entirely avoided. It should be noted that having spaces or air bubbles within the trench 134 may cause the spaces and air bubbles to fill with water or other fluids seeping in from the top of the sidewalk 104. Water, for example, can expand at freezing temperatures, and may damage the integrity of the bottom section 144 or top section 142 in a process commonly known as frosting. Thus, by avoiding or reducing the formation of spaces and air bubbles, the reliability and longevity of the cable installation 108 as a whole can be improved.

Also mentioned above, the filling material 138 can also be non-shrinking upon hardening. That is, the filling material 138 can be non-compressible, non-expandable, with no contraction when it hardens. In some implementations, the filling material 138 may shrink no more than 1 percent of its volume upon drying and hardening at ambient temperature. The non-shrinking property of the filling material reduces or entirely avoids the formation of air bubbles or spaces in the bottom section 144 upon hardening. As discussed above, reducing or avoiding air bubbles or spaces can improve the reliability and longevity of the cable installation 108. In some implementations, the filling material 138 can begin to rigidify within the first hour of being poured or pumped into the trench 134. In some implementations, the filling material 138 may completely rigidify within about three to about twelve hours after being poured or pumped into the trench 134. The dried and rigid filling material 138 may have very low hydraulic permeability. In some implementations, the hydraulic permeability of the filling material 138 can be less than 0.0000001 cm/s. The filling material 138 with low permeability can prevent water from seeping into the trench 134 through the filling material 138, and therefore, reduce any damage caused by frosting. In some implementations, the hardness of the filling material 138 upon rigidification can be substantially equal to or greater than the hardness of the curb 106. In some implementations, a grout sold under the name SUPERGROUT® may be used as the filling material 138. In some other implementations, Portland cement may be used as the filling material 138.

The top section 146 of the trench 134 can be filled with a topping material 142 to cover and seal the trench 134. The topping material 142 can, like the filling material 138, be flowable compound that can rigidify upon drying. In some implementations, the topping material 142 can be configured to adhere to the top surface of the filling material 138 at the interface 140. In some implementations, the topping material 142, unlike the underlying filling material 138, can be compressible or elastic upon rigidifying. The compressibility of the topping material 142 can allow the top sidewalk section 126 to expand in the horizontal direction towards the curb 106 without significant resistance. As such, the topping material can have properties similar to the material used for forming the expansion joint 130 shown in FIG. 2A. The topping material may also act as a sealant so as to prevent any water or fluids from seeping into the trench 134. In some implementations, the topping material can include mastic. In some other implementations, the topping material can include silicone caulking. In some other implementations, any material that is compressible and can provide a seal can be employed.

Machines for Constructing the Cable Installation

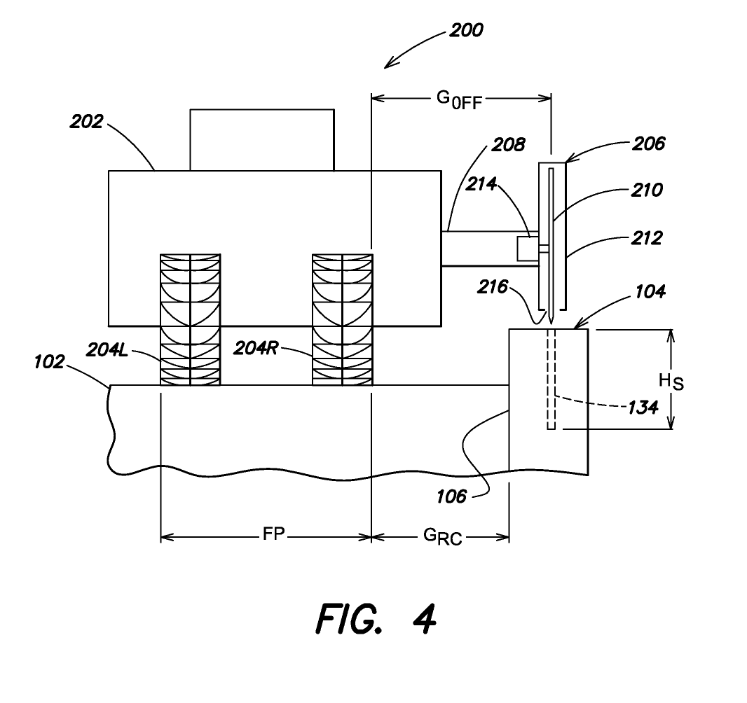

Discussion now turns to the machinery for constructing the cable installation 108 shown in FIG. 3. FIG. 4 shows a rear view of an example cutting machine 200, according to one embodiment of the present invention, for cutting the trench 134 on the sidewalk 104. The cutting machine 200 can also be used for cutting the trench 134 on the same road surface on which the cutting machine is driven, but outside the footprint of the cutting machine. The cutting machine 200 includes a chassis 202 supported by at least three wheels, two of which: rear wheels or tires 204L and 204R, are shown in FIG. 4. In some implementations, the chassis 202 may be supported by tracks instead of wheels. In some implementations, the chassis 202 can be a chassis of a vehicle such as a tractor, truck, etc. The rear wheels 204L and 204R define a footprint FP of the cutting machine 200. More specifically, the footprint FP is the distance between the outer edges of the rear wheels 204L and 204R. In some implementations, FP may be the largest of the distances (determined along the y-axis) between the outside edges of any two wheels, tires or tracks.

The cutting machine 200 also includes a blade housing 206 coupled to the chassis 202 via an offset arm 208. The blade housing 206 can include a circular, rotatable blade 210 and a shroud or cover 212 surrounding the blade 210. The shroud 212 has an opening 216 through which a portion of the blade 210 can be exposed. The blade housing 206 can also include a motor 214 for rotating the blade 210. In various embodiments, the offset arm 208 can extend the blade 210 beyond the outside edge of the wheel 204R nearest to the curb 106 by an offset distance G_{OFF}. In some implementations, the offset distance G_{OFF} can be about 6-12 inches. The offset arm 208 can also provide elevation to the blade 210, and the blade housing 206 as a whole, so that the blade 210 can be positioned to cut the sidewalk 104, which is at an elevation H_{S} with respect to the surface of road 102. In some implementations, as discussed further below, the offset arm 208 and the blade housing 206 can be coupled with a joint that can allow elevation adjustments of the blade housing 206 in the vertical z-direction.

In one embodiment, the offset arm 208 is also configured such that the blade 210 is maintained substantially normal to the sidewalk 104. In other words, the blade 210 is positioned such that the plane of the blade 210 makes as small an angle with the x-z plane as possible. Said in yet another way, the blade 210 is maintained substantially vertical to the x-y plane. It should be noted that maintaining the blade 210 substantially vertical provides several benefits. For one, a substantially vertical blade 210 will result in the blade cutting a substantially vertical trench 134 in the sidewalk 104. As a result, the width W_{T} of the trench 134 will be predictably close to the width of the blade 210. Furthermore, a non-vertical blade 210 cutting any material will experience more wear and tear than a vertical blade 210. Therefore, by maintaining the blade 210 vertical, blades have to be replaced less often for a given distance. In addition, by reducing the frequency of replacement of blades, the frequency of interrupting the cutting operation is also reduced, thereby increasing the throughput of the cutting machine in terms of feet of trench constructed per unit of time. In some other implementation, the offset arm 208 is configured such that the blade 210 is maintained substantially parallel to the inner surface of the curb 106.

During operation, the cutting machine 200 can be positioned on the road 102 near the curb 106, at a distance indicated by G_{RC}, such that the blade 210 is positioned at a location on the sidewalk 104 where the desired trench 134 is to be constructed. The distance G_{RC} can be between about 4 inches to about 6 inches. The blade housing 206 and the rotating blade 210 can subsequently be lowered onto the sidewalk 104 adjacent to the inner surface of the curb 106 to cut the trench 134. While the blade 210 is carrying out the cutting operation, the machine 200 is moved forward in a direction that is substantially parallel to the curb 106. The forward motion of the machine 200 causes the blade 210 to cut a trench 134 in the sidewalk 104, similar to the one discussed above in relation to FIG. 1.

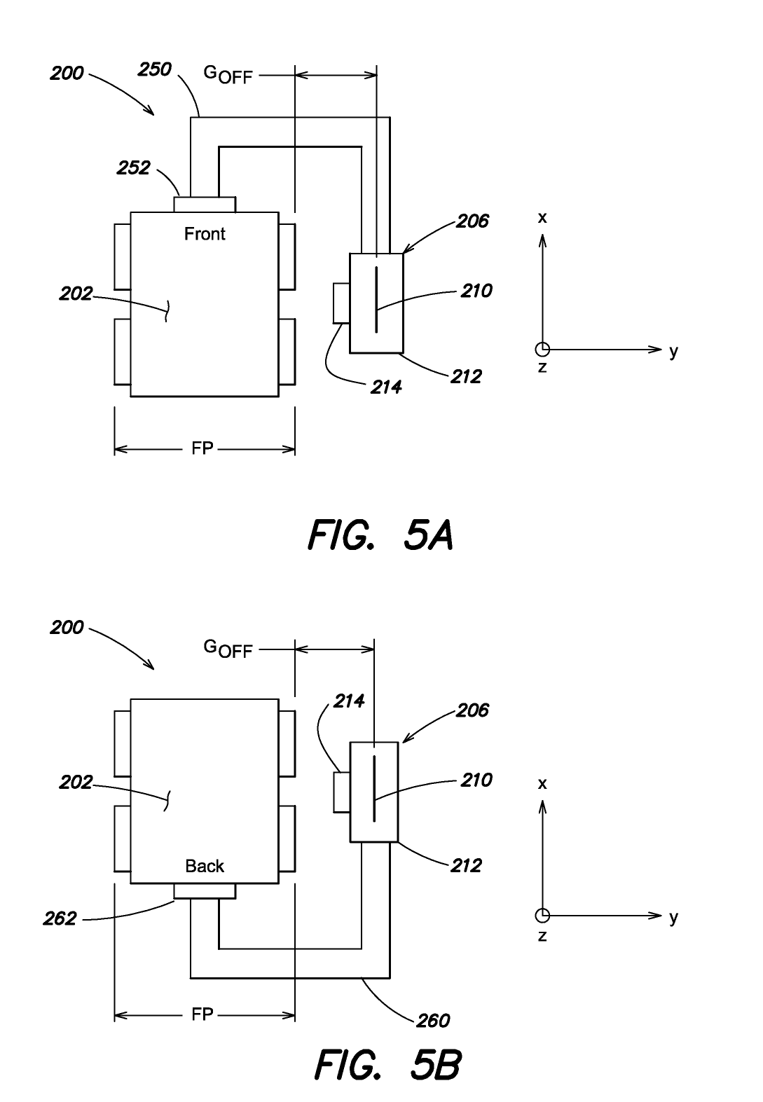

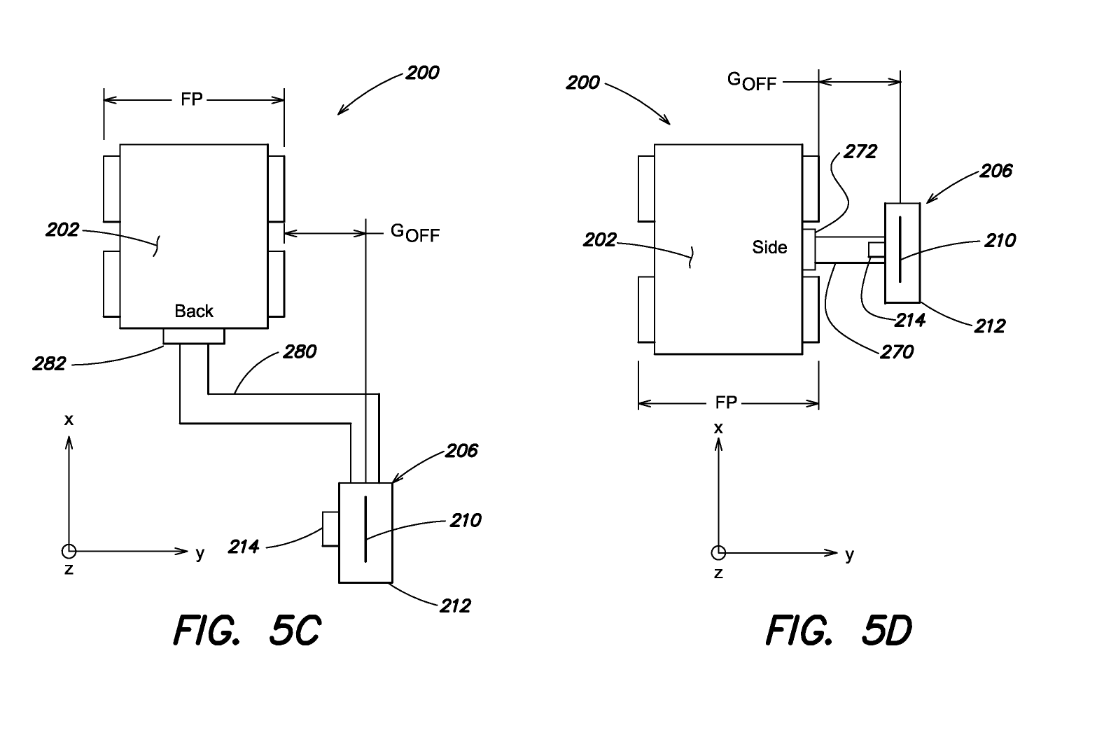

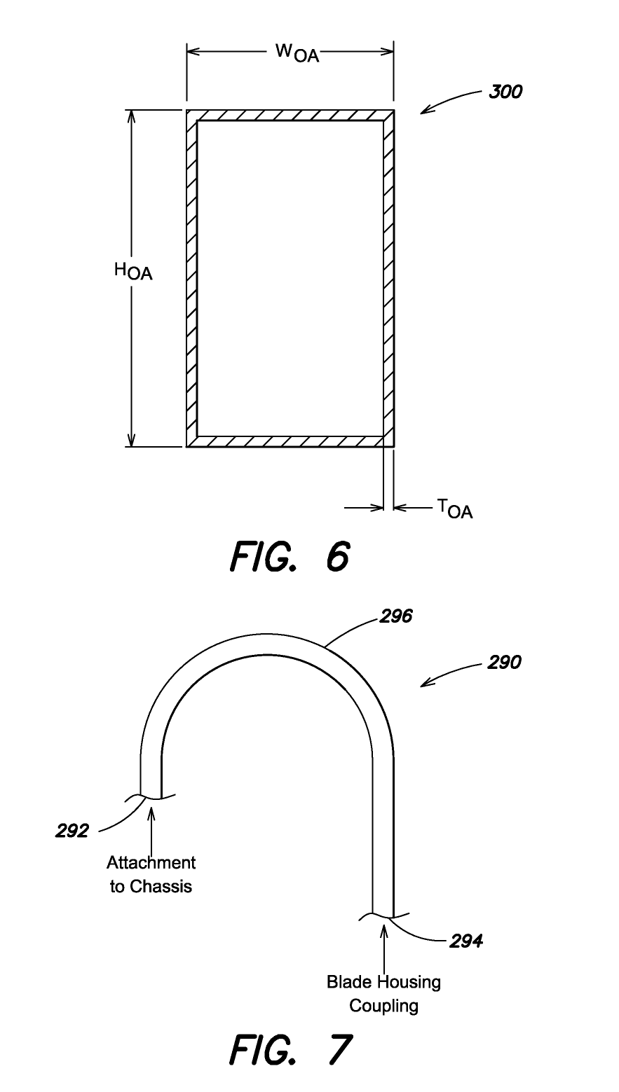

FIGS. 5A-5D show top views of examples of a cutting machine according to various embodiments of the invention. In particular FIG. 5A shows the cutting machine 200 having a front offset arm 250 attached to the front of the chassis 202, FIGS. 5B and 5C show the cutting machine 200 having rear offset arms 260 and 280, respectively, attached to the rear of the chassis 202, and FIG. 5D shows the cutting machine 200 having a side offset arm 270 attached to the side of the chassis 202.

Referring to FIG. 5A, the front offset arm 250 can be similar to the offset arm 208 discussed above in relation to FIG. 4. One end of the front offset arm 250 is attached to the front of the chassis 202 via an attachment 252. The other end of the front offset arm 250 is coupled to the blade housing 206, which includes the blade 210, the shroud 212 and the motor 214. The front offset arm 250 extends out horizontally in the y-direction such that the blade 210 is positioned at a distance G_{OFF} beyond the footprint FP of the cutting machine 200. The front offset arm 250 can also extend back horizontally in the x-direction so as to position the blade 210 within convenient visual range of an operator operating the cutting machine 200. Thus, during operation, the operator of the cutting machine 200 can position the cutting machine at an appropriate distance G_{RC} from the curb 106 (as shown in FIG. 4) so that the blade 210 is positioned over the desired location on the sidewalk 104.

In FIG. 5B as well, the rear offset arm 260 can be similar to the offset arm 208 discussed above in relation to FIG. 4. One end of the rear offset arm 260 is attached to the rear of the chassis 202 via an attachment 262. The other end of the rear offset arm 260 is coupled to the blade housing 206. Similar to the front offset arm 250 of FIG. 5A, the rear offset arm 260 also extends out horizontally in the y-direction such that the blade 210 is positioned at the offset distance G_{OFF} beyond the footprint FP of the cutting machine 200. Furthermore, the rear offset arm 260 can extend horizontally in the x-direction towards the front of the cutting machine 200 so as to position the blade 210 within convenient visual range of the operator operating the cutting machine 200.

FIG. 5C shows another example of a cutting machine 200 having an offset arm 280 attached to the rear of the chassis 202 similar to the offset arm 260 shown in FIG. 5B. But in contrast with the offset arm 260, the offset arm 280 of FIG. 5C extends in the opposite x-direction. This places the blade 210 behind the cutting machine 200. In some implementations, due to the forces created by the rotating blade 210 during operation, it is preferable to pull the blade 210, as implemented in FIG. 5C, instead of pushing the blade, as is implemented in FIG. 5B.

Finally, FIG. 5D shows a linear side offset arm 270, which can be similar to the offset arm 208 discussed above in relation to FIG. 4. One end of the linear side offset arm 270 is attached to the side of the chassis 202 via an attachment 272. The other end of the side offset arm 270 is coupled to the blade housing 206. The side offset arm 270 extends out horizontally in the y-direction such that the blade 210 is positioned at the offset distance G_{OFF} beyond the footprint FP of the cutting machine 200. Unlike the front offset arms (250, 260, and 280) shown in FIGS. 5A-5C, the side offset arm 270 may not need to extend horizontally in the x-direction to position the blade 210 within convenient visual range of the operator.

The offset arms discussed above in relation to FIGS. 4-5C can be designed such that they have sufficient strength to support the blade housing 206, which can weigh a few hundred pounds. To that end, the offset arms can be made using high strength materials, such as, but not limited to, steel, mild steel, iron, alloys, etc. The shape of the offset arms can also affect the strength of the offset arm. In some implementations, the offset arm can have a hollow rectangular shape cross-section, such as the one shown in FIG. 6. The offset arm 300 shown in FIG. 6 is substantially rectangular in shape with a height H_{OA}, a width W_{OA} and a thickness T_{OA}. In some implementations, the height H_{OA} of the offset arm 300 can be in the range of 6-10 inches, the width W_{OA} of the offset arm 300 can be in the range of 3-5 inches, and a thickness T_{OA} of the offset arm 300 can be in the range of ¼^{th}-¾^{th} of an inch.

In some implementations, the offset arm 208 shown in FIG. 4 can have at least one portion that is curved. For example, FIG. 7 shows a top view of an offset arm 290 having a U-shaped curved portion 296. One end 292 of the offset arm 290 can be attached to the chassis 202 while the other end 294 of the offset arm can be attached to the blade housing 206.

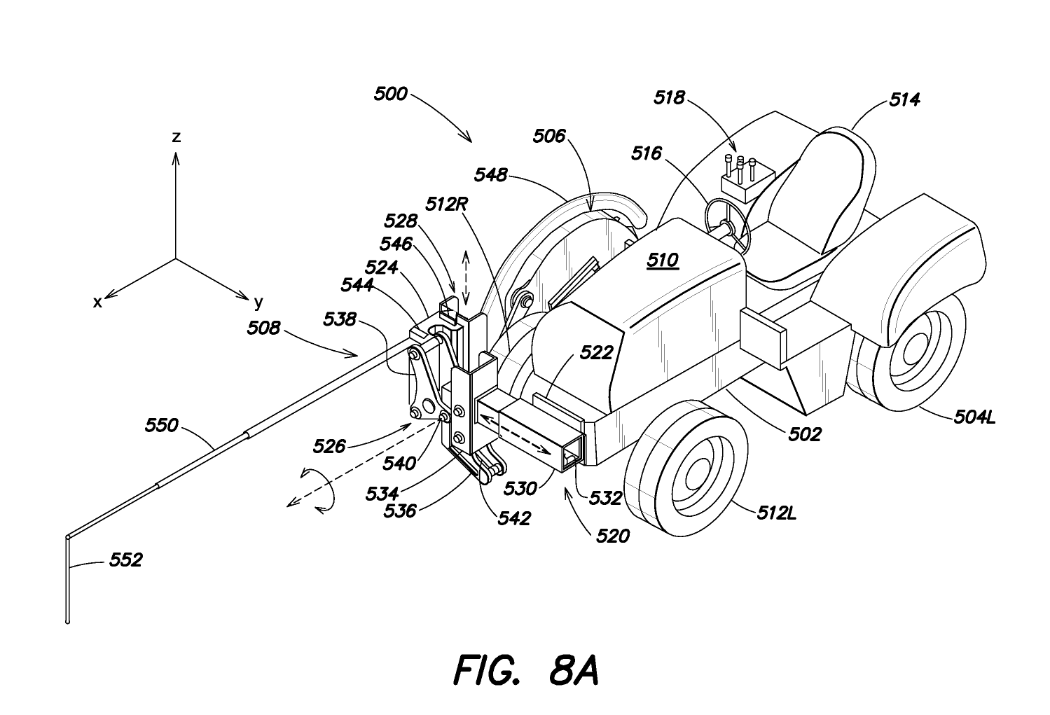

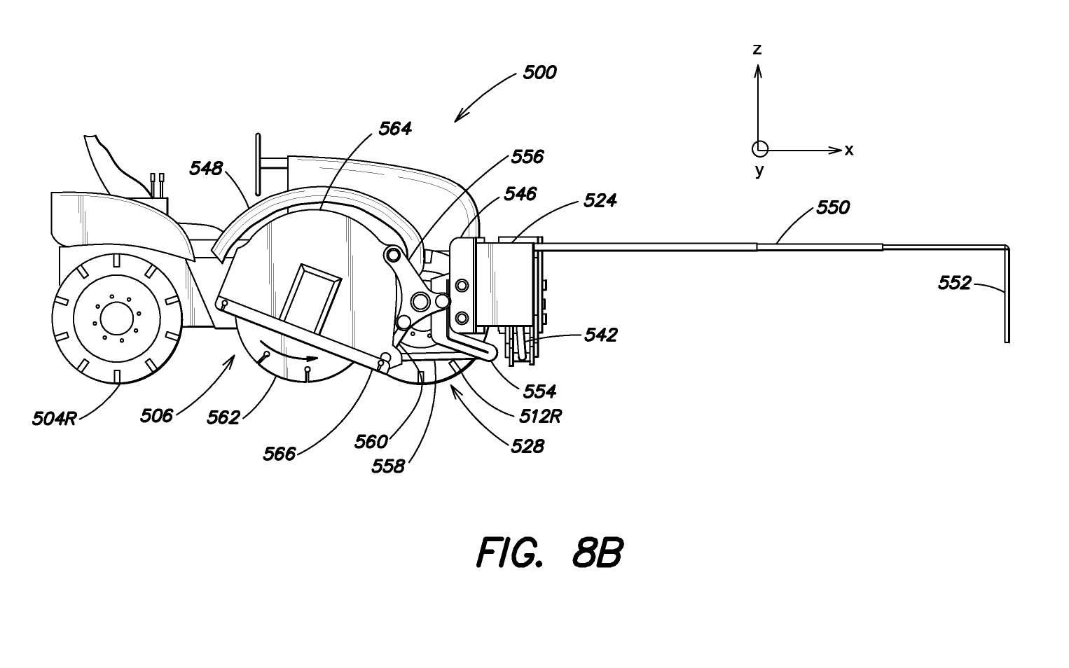

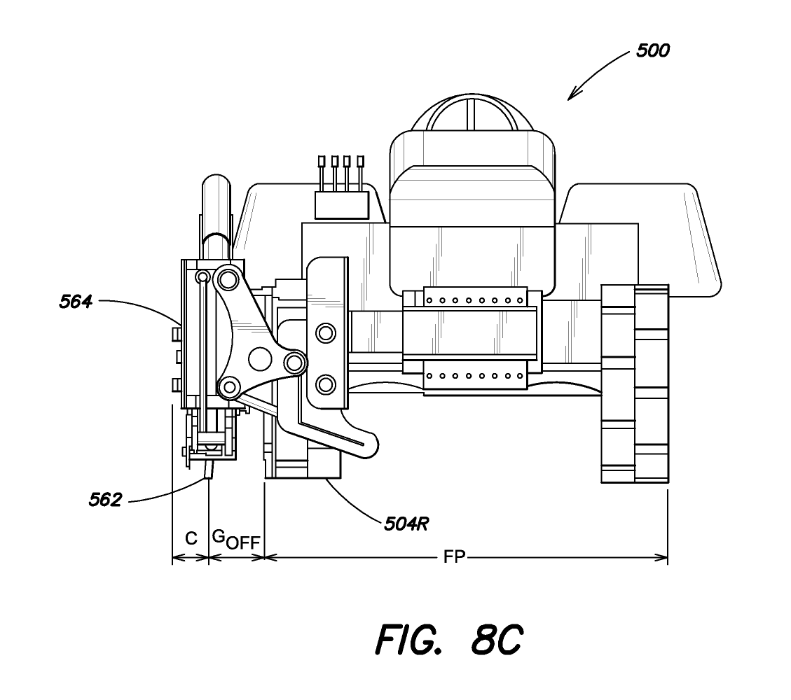

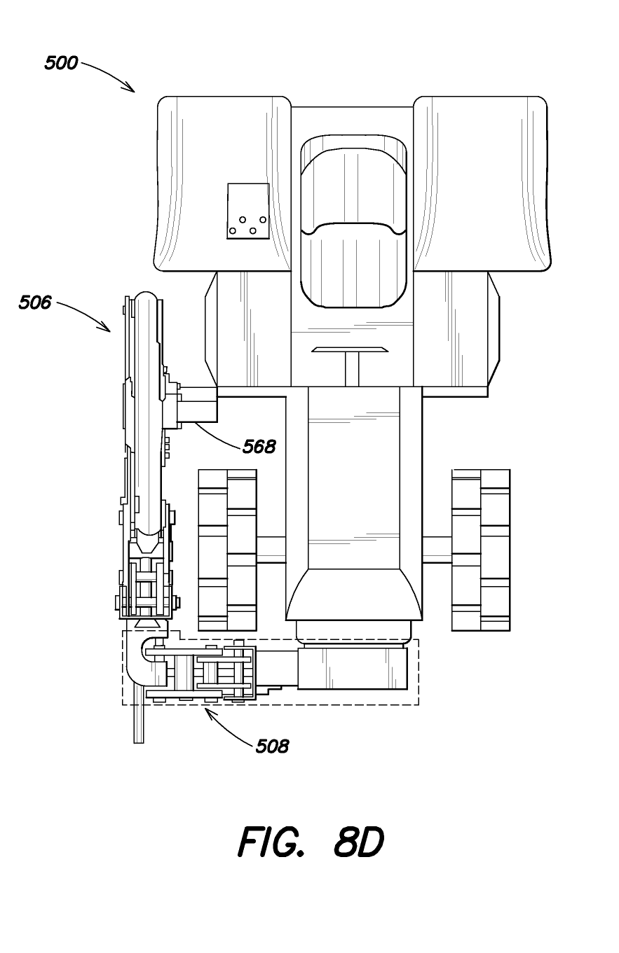

FIGS. 8A-8D show various views of a cutting machine 500 having an offset arm attached to the front of the machine 500, according to various embodiments of the present invention. In particular, FIG. 8A shows a perspective view of the cutting machine 500 that can be employed for cutting a trench along an inner surface of a curb. For example, the cutting machine 500 could be utilized for constructing the trench 134, as shown in FIG. 3, along the inner surface 124 of the curb 106. The cutting machine 500 can be similar to the cutting machine 200 discussed above in relation to FIG. 4. The cutting machine 500 is configured such that the offset arm that supports a blade housing is attached to the front of the cutting machine 500. In this respect, the cutting machine 500 can be similar to the cutting machine 200 discussed above in relation to FIG. 5A.

Specifically, the cutting machine 500 includes a tractor 510, an offset arm 508 attached to the front of the tractor 510, and a blade housing 506 attached to the offset arm 508 (also shown more clearly in FIG. 8D). The tractor 510 is supported by a chassis 502 and four wheels, three of which: a front left wheel 512L, a front right wheel 512R, and a rear left wheel 504L can be seen in FIG. 8A. The tractor 510 can be driven on the road alongside a curb, such as the curb 106 shown in FIG. 4, by an operator located at an operating station 514. The operating station includes a steering wheel 516 that steers the tractor, and control panel levers 518 for controlling various aspects of the cutting machine 500. The tractor 510 can be any vehicle that can provide an attachment or mount for the offset arm 508, and may include tractors commercially available from various manufacturers such as DITCHWITCH®, VERMEER®, etc.

The offset arm 508 is attached to the front of the chassis 502. Specifically, a first offset arm portion 520 of the offset arm 508 is attached to the chassis 502 by a chassis attachment plate 522. The first offset arm portion 520 extends outwards in the y-direction away from the front left wheel 512L to be coupled to a second offset arm portion 524 via an arm tilt assembly 526. The second offset arm portion 524, in turn, is coupled to the blade housing 506 via a linkage assembly 528.

In some implementations, the first offset arm portion 520 can have an adjustable length. The ability of adjusting the length of the first offset arm portion 520 can be used to impart translational motion to the blade housing 506. As discussed above in relation to FIG. 4, the offset distance G_{OFF} represents the distance between the outer edge of the wheel nearest to the curb and the plane of the blade. Thus, the distance G_{OFF} can be varied as desired by adjusting the length of the first offset arm portion 520. Having the ability to vary the offset distance G_{OFF} gives the operator the freedom to employ a combination of both the positioning of the tractor 510 with respect to the curb and the extension of the first offset arm portion 520 to accurately position the blade over the desired location on the sidewalk. In some instances, the road surface adjacent to the curb can be uneven due to uneven paving or due to the presence of gutters. In such instances, the additional extension in the offset distance G_{OFF} provided by the first offset arm portion 520 can allow the operator to drive the tractor 510 further away from the curb and clear of the uneven road surface. In some implementations, the first offset arm portion 520 can adjust the offset distance G_{OFF} by 4-12 inches.

In some implementations, the first offset arm portion 520 can include two telescopic members: an outer telescopic member 530 and an inner telescopic member 532. One side of the outer telescopic member 530 is attached to the chassis attachment plate 522. One end of the inner telescopic member 532 is concentric to, and can slide in and out of, an open end of the outer telescopic member 530. The movement of the inner telescopic member 532 in relation to the outer telescopic member 530 can be imparted by a piston (not shown) controlled by operator via control panel levers 518. In some implementations, the piston can be controlled hydraulically, but in other implementations, the piston can be electronically or pneumatically controlled. The other end of the inner telescopic member 532 is coupled to the arm tilt assembly 526 via a first attachment plate 534. In some implementations, the inner telescopic member 532 can be welded to the first attachment plate 534.

As mentioned above, the arm tilt assembly 526 couples the first offset arm portion 520 to the second offset arm portion 524. The arm tilt assembly 526 can be operated to provide a tilting motion to the blade housing 506. In other words, the operation of the tilt assembly can vary the angle the plane of the blade makes with the sidewalk. As discussed above, during the operation of the blade, it is desirable that the blade remain substantially parallel to the inner surface of the curb. However, in some instances, some portions of the road over which the tractor is driven may be uneven. This unevenness may cause the tractor 510 to tilt. The tilting of the tractor 510 can cause the offset arm 508 and, in turn, the blade housing 506 and the blade to also tilt. Thus, uneven road conditions may cause the blade to deviate from being parallel to the inner surface of the curb. The arm tilt assembly 526 can be employed to adjust the tilt of the blade housing 506 and the blade independently of the tilt in the tractor 210. In this manner, if the tractor 210 tilts in one direction, the arm tilt assembly 526 can be operated to tilt the blade housing 506 and the blade in the opposite direction such that the blade is maintained substantially parallel with the inner surface of the curb.

The arm tilt assembly 526 includes a pivot frame 536 attached to the first attachment frame 534. The tilt pivot frame 536, in turn, is attached to a tilt lift arm 538 via a rotating joint 540. The tilt pivot frame 536 and the tilt lift arm 538 are also coupled via a tilt piston 542. The tilt piston 542 can be hydraulically, pneumatically, or electrically controlled and operated by the operator via the control panel levers 518. By activating the tilt piston 540, the tilt lift arm 538 can be rotated with respect to the tilt pivot frame 536 about the rotating joint 540. The tilt piston 542 can be operated such that the tilt lift arm 538 can rotate about the rotating joint 540 (i.e., about the x-axis) in both clockwise and anticlockwise direction. As the tilt lift arm 538 is attached to the second offset arm portion 524, which in turn is coupled to the blade housing 506, the rotation of the tilt lift arm 538 imparts a tilting motion to the blade housing 506 and the blade.

Thus, during forward motion of the tractor 210 and while the blade is being operated, any tilt in the tractor 210 can be compensated by operating the arm tilt assembly 526 to tilt the blade housing 506 in the opposite direction. In this manner, the blade can be maintained substantially parallel to the inner surface of the curb.

In some implementations, the tilt of the blade housing 506 can be manually controlled by the operator using the control panel levers 518. In some implementations, the second arm portion 524 can include a tilt indicator 544, which can provide the operator with a visual indication of the tilt of the blade housing 506. The operator can monitor the tilt indicator 544 and upon detecting a tilt, can control the arm tilt assembly 526 until the tilt indicator 544 indicates that the blade housing 506 is substantially parallel to the inner surface of the curb.

In some other implementations, the tilt control of the blade housing 506 can be automatic. For example, the blade housing 506 can include an electronic tilt sensor (not shown) that is configured to output an electronic signal (digital or analog) indicating the tilt of the blade housing 506. A controller can be configured to receive the output signal from the tilt sensor and compare the received tilt value to a preset tilt value. In some implementations, preset tilt value may represent the tilt of the inner face of the curb. In some other implementations, the preset tilt value may represent zero tilt with respect to the sidewalk 104. If the indicated tilt value deviates from the preset tilt value, the controller can send a control signal to an actuator that actuates the tilt piston 542 in the arm tilt assembly 526. The control signal may include the extent and direction in which the tilt piston 542 is to be operated based on the deviation of the tilt value from the present tilt value. Various control tilt values may be stored in a memory of the controller, such that appropriate control signals based on the received tilt values can be generated.

As mentioned above, the arm tilt assembly 526 is attached to the second arm portion 524. The second arm portion 524, in turn, is coupled to the blade housing 506 via a linkage assembly 528. The linkage assembly 528 includes z-joint 546 that can allow the blade housing 506 to be lifted or lowered, i.e. moved along the z-axis. The lifting and lowering motion of the blade housing 506 allows the cutting machine 500 to operate the blade housing 506 on various elevations, such as a sidewalk. The z-joint 546 can be controlled hydraulically, pneumatically, or electrically via the control panel levers 518. In some implementations, the range of vertical movement provided by the z-joint 546 can be up to about 12 inches.

In one embodiment, the blade housing 506 also includes a vacuum hose 548 to carry debris and cuttings resulting from the cutting operation of the blade. One end of the vacuum hose 548 is connected to a vacuuming machine that includes a vacuuming pump. The other end of the vacuum hose 548 is positioned near the blade in the path of the stream of debris resulting from the cutting operation. Vacuuming concurrently or simultaneously with the cutting operation advantageously removes the debris from the trench cut by the blade and at the same time prevents the debris to settle back into the trench. Thus, cutting operation of the blade results in an evacuated trench that is ready for the next step of cable installation. Vacuuming concurrently with the rotation of the blade also results in air flow around the blade, which air flow aids in cooling the blade.

In some implementations, the cutting blade can also include a curb pole 550 which extends forward from the offset arm 508 towards the front of the cutting machine 500. The curb pole 550 can be utilized by the operator as a steering aid to maintain the alignment of the blade with the curb during a cutting operation. One end of the curb pole 550 can be attached to the offset arm 508. The other end of the curb pole 550 can include a hinged curb stick 552. The curb stick 522 extends downward and comes in close proximity with the curb. Furthermore, the curb pole 550 is positioned on the offset arm 508 such that the curb stick 522 lies within the plane of the blade. The operator can gently steer the tractor 510 such that the bottom of the curb stick 522 touches or is in close proximity over the inside of the curb where the trench is to be cut. By maintaining the curb stick 522 over the inside of the curb, and simultaneously inspecting the current location of the blade on the curb, the operator can ensure that the trench is created at the desired location.

FIG. 8B shows a side view of the cutting machine 500 shown in FIG. 8A. FIG. 8B shows the blade housing 506 coupled to the second arm portion 524 via a linkage assembly 528. Details of the z-joint 546 have been discussed above. The linkage assembly 528 also includes a pivot frame 554 attached to the z-joint 546. The other end of the pivot frame 554 is coupled to a lift arm 556, via a rotating joint. The lift arm 556, in turn, is coupled to the blade housing 506. The linkage assembly 528 also includes a first piston 558 coupled between the pivot frame 554 and one end of the blade housing 506. Furthermore, the linkage assembly 528 includes a second piston 560 coupled between the lift arm 556 and at the same end of the blade housing 506 to which the first piston 558 is coupled.

Controlling the first piston 558 and the second piston 560 can allow the linkage assembly 528 to provide at least two separate forms of motion to the blade housing 506. For example, the blade housing 506 can be moved in an arc around rotating joint connecting the pivot frame 554 to the lift arm 556. Additionally, the blade housing 506 can be slightly rotated around the y-axis.

The blade housing 506 includes an outer shroud 564 that houses the blade 562 on the outside of the blade housing 506. The blade housing 506 also includes an inner shroud (not visible in this view) that houses the blade 562 on the inner side of the blade housing 506. The outer shroud 564 and the inner shroud together completely surround the blade 562 on all directions except the bottom exposed portion of the blade 562. One end of the vacuum hose 548 is attached to an opening in the inner or outer shroud 564 near the front of the blade 562. The lower portions of the outer shroud 564 and the inner shroud are configured to press down against the sidewalk and the curb when the blade 562 is cutting the trench. Surfaces of these lower portions that come in contact with the curb and the sidewalk are coated with plastic, such as neoprene, so that the curb and the sidewalk are not scratched. The outer shroud 564 also includes a height adjustable lower portion 566 that can be adjusted to account for uneven elevations of the sidewalk in relation to the curb. In some implementations the outer shroud 564 can include vents or louvers (3-4 inches long and ⅜^{th} of an inch wide) to allow additional flow of air into the blade housing 506 and be sucked by the vacuum hose 548 along with the debris.

The blade 562 can have a thickness and diameter sufficient to cut the desired trench, such as the trench 134 shown in FIG. 4. The thickness of the blade 562 can be one factor in determining the width (e.g., width W_{T} shown in FIG. 3) of the trench, while the diameter of the blade 562 can be one factor in determining the depth (e.g., depth D_{T} shown in FIG. 3) of the trench. In some implementations, the blade 562 can be a diamond blade with a diameter between about 30 to about 36 inches, and a width between about 0.5 inch to about 1.5 inches.

FIG. 8C shows a front view of the cutting machine 500 according to one embodiment. In particular, FIG. 8C clearly indicates the offset distance G_{OFF} measured from the outside edge of the rear right wheel 504R to the blade 562. FIG. 8C also shows the footprint FP of the cutting machine 500.

The cutting machine 500 provides the ability to cut a trench outside the footprint of the cutting machine. Furthermore, FIG. 8C shows a shoulder distance C measured from the outermost edge of the outer shroud 564 to the blade 562. It is desirable to keep the shoulder distance C as small as possible (between about 2 to about 4 inches) to avoid contact of the outer shroud 564 with installations such as parking meters, fire hydrants, traffic signposts, etc., on the sidewalk or on the road during operation. The shoulder distance C can be reduced by eliminating protruding bolts and lugs that attach the outer shroud 562 to the inner shroud.

FIG. 8D shows a top view of the cutting machine 500. In particular, FIG. 8D shows a motor 568 coupled to the inner shroud of the blade housing 506. The motor 568 is coupled to the blade 562 (shown in FIG. 8B) and provides rotational motion to the blade. In some implementations, in which the blade is a diamond blade, the motor 568 can provide a rotation of about 1200 rpm to the blade 562. In some other implementations, in which the blade includes carbide bits, the motor can provide a rotation of about 350 to 400 rpm. The motor 568 can be a hydraulically, pneumatically, or electrically controlled motor. In some implementations, the motor 568 rotates the blade 562 in an anticlockwise direction when viewed from the side, as shown in FIG. 8B. Alternatively, the motor 568 can rotate the blade 562 in the clockwise direction.

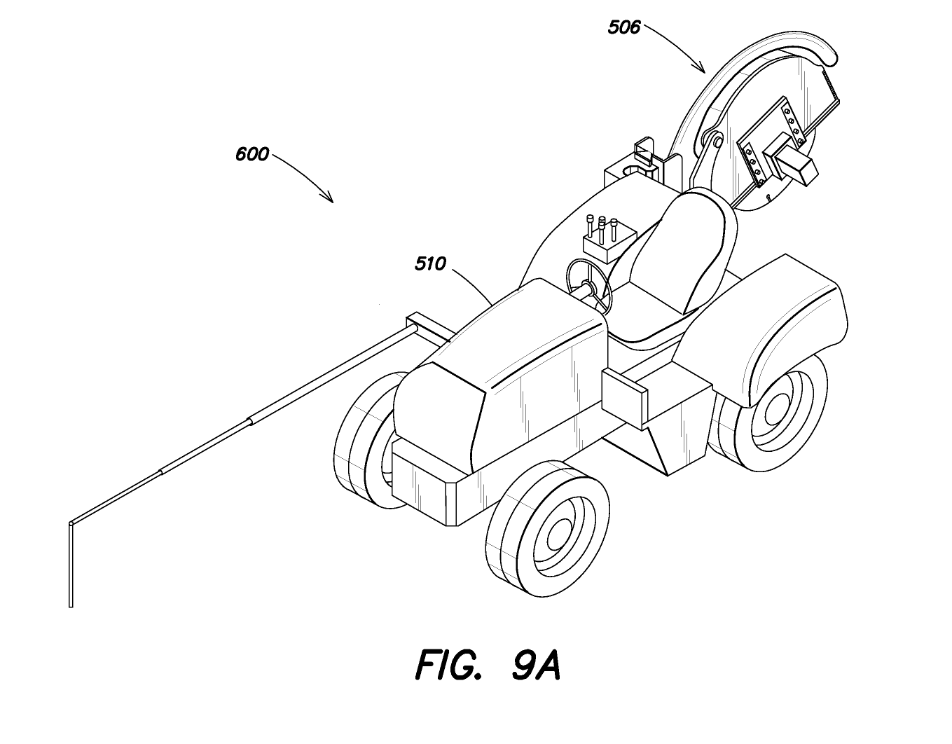

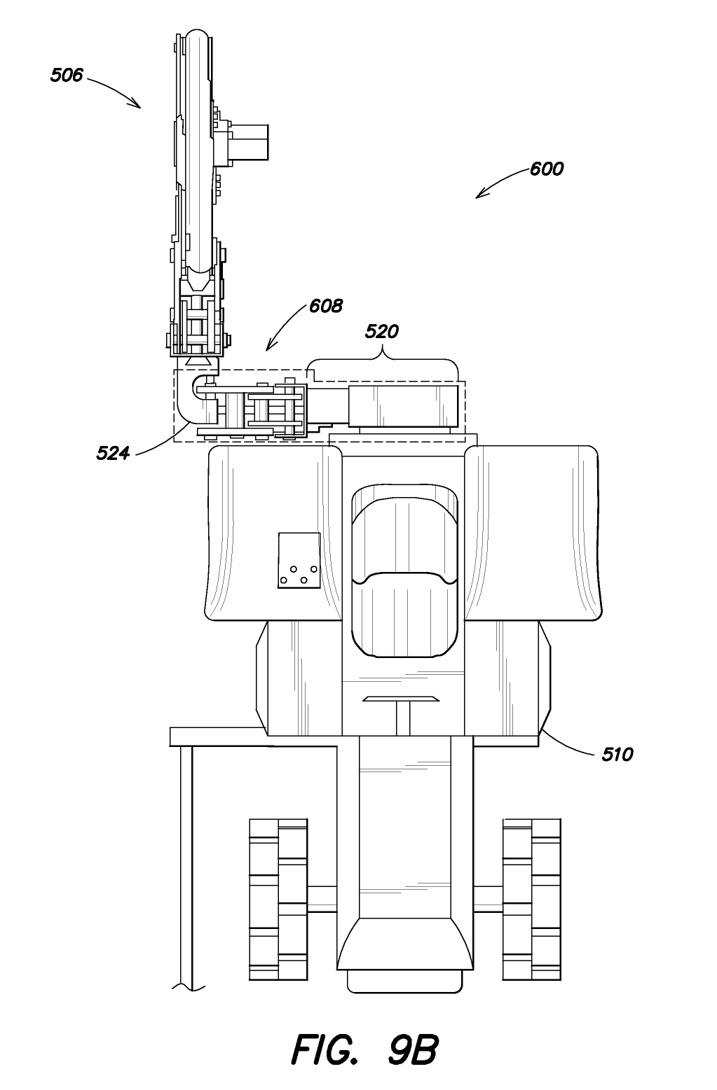

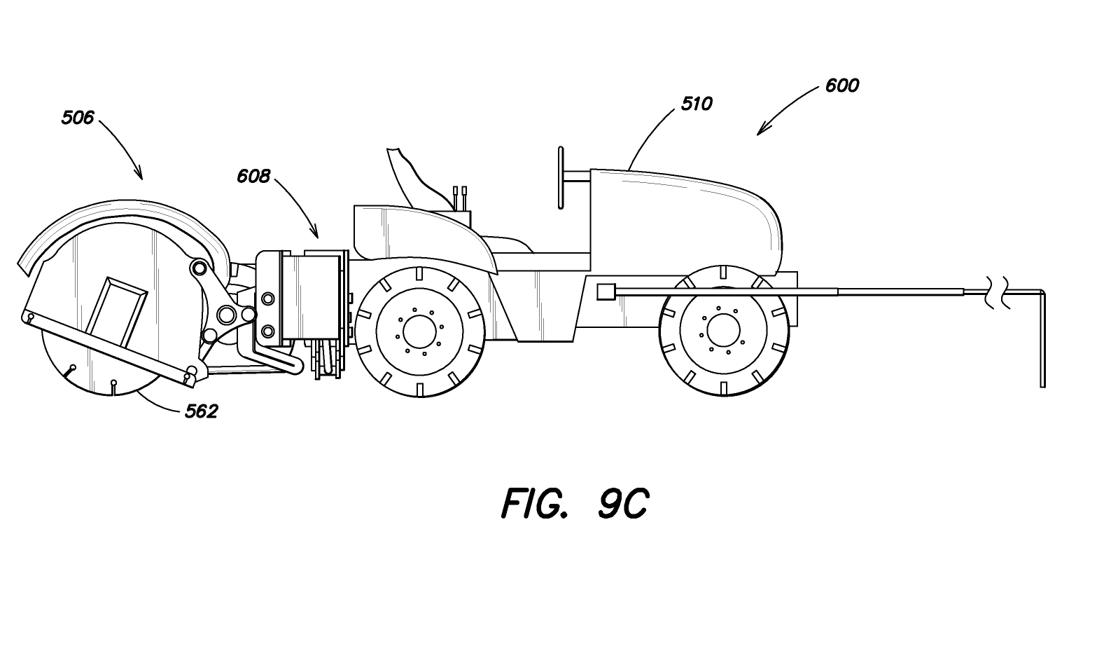

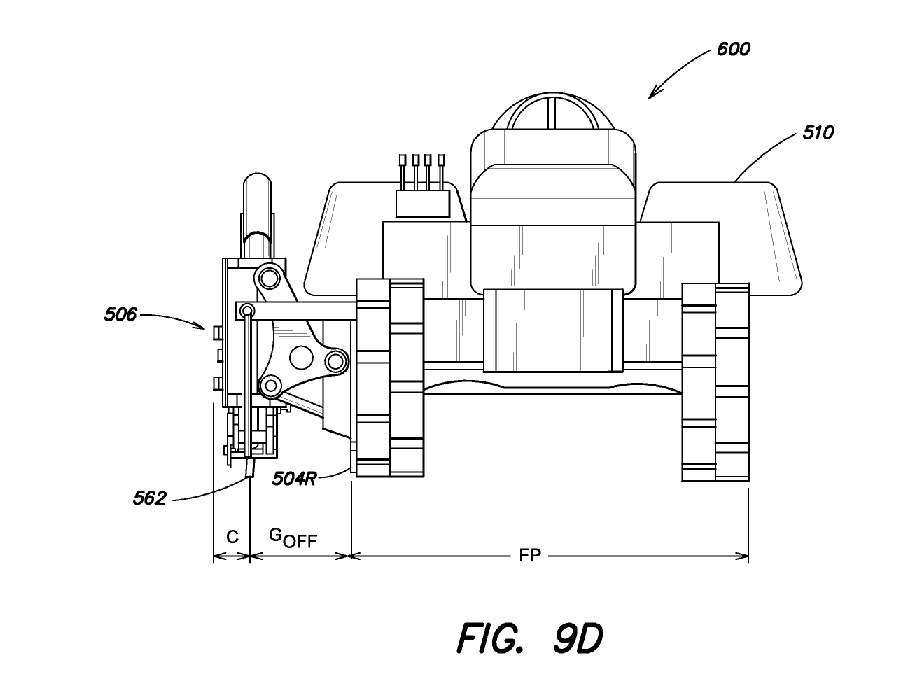

FIG. 9A-9D show various views of a cutting machine in which the offset arm supporting the blade housing is attached to the rear of a tractor, according to one embodiment of the present invention. Specifically, FIG. 9A shows a perspective view of the cutting machine 600. The cutting machine 600 shown in FIG. 9A can be similar to the cutting machine 200 discussed above in relation to FIG. 5C, in which the offset arm is attached to the rear of the chassis.

The attachment of an offset arm to the rear of the tractor 510 is more clearly seen in FIG. 9B, which shows the top view of the cutting machine 600. The cutting machine 600 includes an offset arm 608 attached to the rear of the tractor 510. All the remaining components of the cutting machine 600 are similar to the components of the cutting machine 500 described above in relation to FIGS. 8A-8D, and are therefore not discussed further.

FIG. 9C shows a side view of the cutting machine 600 shown in FIG. 9A. The offset arm 608 is configured in such a way that the blade housing 506 is pulled by the tractor 510 during operation. In some implementations, due to the forces created by the rotating blade 562 (in the anticlockwise direction) during operation, it is preferable to pull the blade, as shown in FIG. 9C, instead of pushing the blade.

FIG. 9D shows a front view of the cutting machine 600 shown in FIG. 9A. In particular, FIG. 9D shows the offset distance G_{OFF}, the shoulder distance C, and the footprint FP of the cutting machine 600. As can be seen, the cutting machine 600 provides the ability to cut a trench outside the footprint of the cutting machine 600.

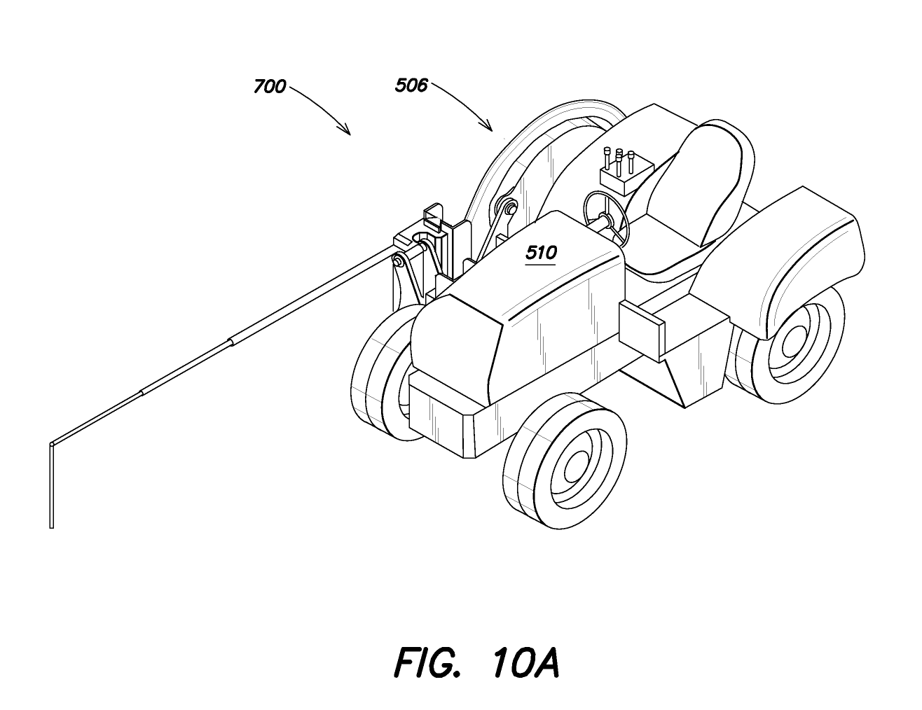

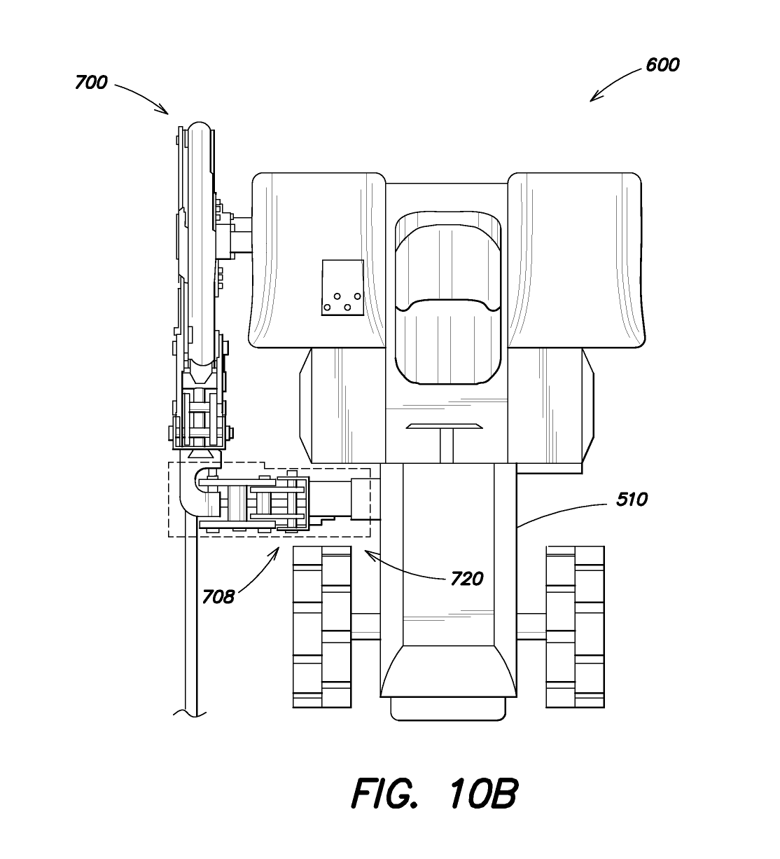

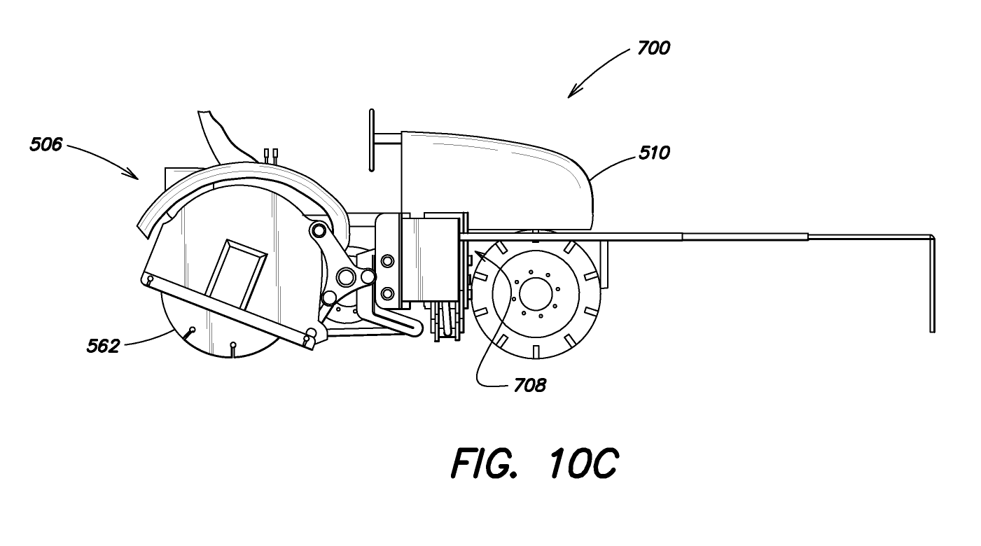

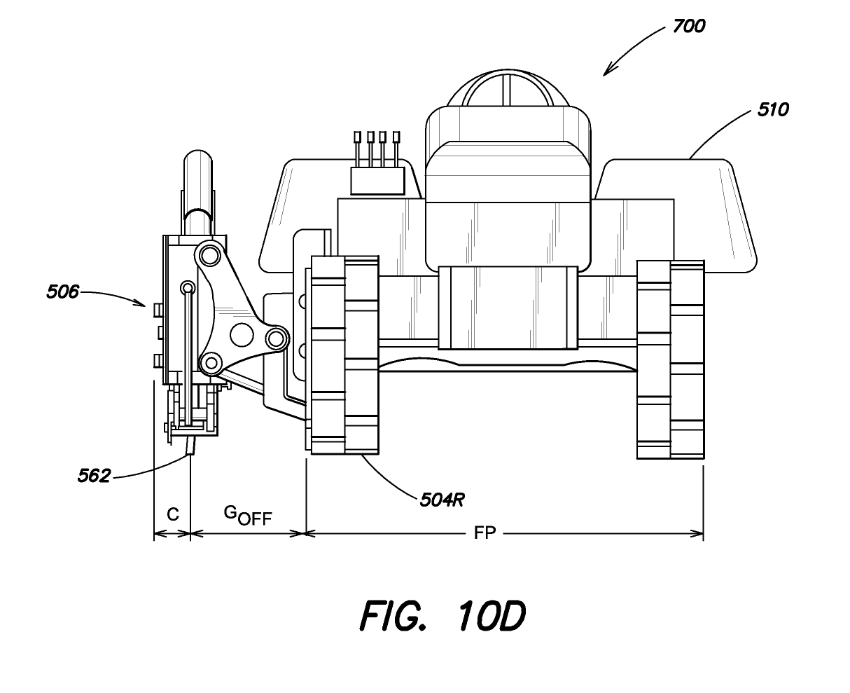

FIGS. 10A-10D show various views of a cutting machine 700 in which the offset arm is attached to the side of the cutting machine 700, according to one embodiment of the present invention. Specifically, FIG. 10A shows a perspective view of the cutting machine 700. The cutting machine 700 includes the blade housing 506 disposed on the side of the tractor 510 by an offset arm (not visible) that is attached to the side of the tractor 510. The components of the cutting machine 700 shown in FIG. 10A are similar to those discussed above in relation to FIG. 8A, and are therefore, not discussed further.

The attachment of the offset arm 708 to the side of the tractor 510 is more clearly seen in FIG. 10B. In particular, the side offset arm 708 is attached to the side of the tractor 510. The cutting machine 600 shown in FIG. 10B can be similar to the cutting machine 200 discussed above in relation to FIG. 5D, in which the offset arm 270 is attached to the side of the chassis 202. The offset arm 708 differs from the offset arm 608 (as shown in FIG. 8D) and the offset arm 708 (as shown in FIG. 9B) in that a first offset portion 520 is not attached on its side to the tractor 510. Instead, the first offset portion 520 is attached to the tractor 510 at one of its ends. However, the first offset portion 520 can function in a manner similar to the first offset portion 520 of FIG. 8A.

FIG. 10C shows a side view of the cutting machine 700 shown in FIG. 10A. The offset arm 708 is attached to the front of the blade housing 506. This results in the tractor 510 pulling the blade 562 during operation. As discussed above, it is preferable to pull the blade when the blade is rotating in the anti-clockwise direction.

FIG. 10D shows a front view of the cutting machine 700 shown in FIG. 10A. In particular, FIG. 10D shows the offset distance G_{OFF}, the shoulder distance C, and the footprint FP of the cutting machine 700. As can be seen, the cutting machine 700 provides the ability to cut a trench outside the footprint of the cutting machine 700.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A method, comprising:
A) forming a trench along an inner face of a street curb, wherein:
the street curb has an exposed top face, a buried bottom face, and a partially exposed outer face adjacent to and abutting a road surface;
at least a portion of the inner face of the street curb, prior to A), is adjacent to and abutting a sidewalk material;
the exposed top face of the street curb defines an x-y plane of a reference coordinate system, wherein a y-axis of a coordinate system is essentially normal to the outer face and the inner face of the street curb, an x-axis is essentially parallel to the outer face and the inner face of the street curb, and a z-axis is normal to the x-y plane; and
the trench is formed in A) such that the trench includes a first vertical sidewall substantially constituted by the inner face of the street curb and a second vertical sidewall constituted at least in part by the sidewalk material.

2. The method of claim 1, wherein the trench has a depth along a vertical dimension essentially parallel to the z-axis, extending downward from the exposed top face of the street curb, of from approximately 5 inches to approximately 15 inches.

3. The method of claim 2, wherein the depth of the trench is from approximately 10 inches to approximately 12 inches.

4. The method of claim 1, wherein the trench has a width along a lateral dimension essentially parallel to the y-axis, between the first vertical sidewall and the second vertical sidewall, of from approximately 0.5 inches to approximately 1.5 inches.

5. The method of claim 1, wherein:
the street curb has a height, between the exposed top face and the buried bottom face, of from approximately 12 inches to approximately 18 inches;
the street curb has a width, between the outer face and the inner face, of from approximately 6 inches to approximately 8 inches;
an exposed top surface of the sidewalk material is substantially coplanar with the exposed top face of the street curb; and
the sidewalk material has a thickness, extending downward from the exposed top surface of the sidewalk and essentially parallel to the z-axis, of from approximately 4 inches to approximately 6 inches.

6. The method of claim 1, wherein:
the sidewalk material is disposed on top of a native backfill material;
a first portion of the second vertical sidewall of the trench is constituted by the sidewalk material; and
a second portion of the second vertical sidewall of the trench is constituted by the native backfill material.

7. The method of claim 1, wherein the street curb is formed of an aggregate material.

8. The method of claim 1, wherein the street curb is granite.

9. The method of claim 1, wherein the street curb is concrete.

10. The method of claim 1, wherein the street curb includes a curb protection element disposed on at least a first portion of the partially exposed outer face and a second portion of the exposed top face.

11. The method of claim 1, wherein the sidewalk material is concrete.

12. The method of claim 1, wherein the sidewalk material includes at least one cobblestone.

13. The method of claim 1, wherein the sidewalk material includes at least one brick.

14. The method of claim 1, wherein the sidewalk material includes at least one paver.

15. The method of claim 1, wherein:
the street curb and the sidewalk material comprise a same monolithically poured material, wherein a boundary between the street curb and the sidewalk material is provided by a groove made in the monolithically poured material prior to hardening of the monolithically poured material; and
A) comprises forming the trench along the groove between the street curb and the sidewalk material.

16. The method of claim 1, wherein:
prior to A), the sidewalk material abuts the inner face of the street curb via an expansion joint; and
A) comprises forming the trench along the expansion joint between the inner face of the street curb and the sidewalk material.

17. The method of claim 1, wherein A) comprises:
A1) cutting the trench with a blade mechanically coupled to a vehicle disposed on the road surface.

18. The method of claim 17, wherein A1) comprises:
advancing the vehicle along the road surface in a direction substantially parallel to the x-axis while rotating the blade so as to cut the trench.

19. The method of claim 17, wherein A1) comprises:
rotating the blade in a counterclockwise direction so as to cut the trench.

20. The method of claim 17, wherein:
the vehicle has a footprint over the road surface and includes at least one tire having a tire surface facing the partially exposed outer face of the street curb;
the blade is mechanically coupled to the vehicle via an offset arm such that a blade plane of the blade is at least approximately parallel to a tire surface plane of the tire surface and laterally offset from the tire surface plane such that the blade plane is outside of the footprint of the vehicle; and
A1) comprises positioning the vehicle on the road surface such that the blade plane is adjacent to and at least approximately parallel with the inner face of the street curb.

21. The method of claim 20, wherein the offset arm includes at least one nonlinear portion.

22. The method of claim 20, wherein the offset arm includes at least one L-shaped portion.

23. The method of claim 20, wherein the offset arm includes at least one partially U-shaped portion.

24. The method of claim 20, wherein the offset arm includes:
at least one mechanical joint;
a first offset arm portion coupled to the at least one mechanical joint; and
a second offset arm portion coupled to the at least one mechanical joint,
wherein the at least one mechanical joint provides for translation and/or rotation of the first offset arm portion relative to the second offset arm portion.

25. The method of claim 24, wherein the at least one mechanical joint includes at least one hydraulic coupling.

26. The method of claim 20, wherein a lateral offset distance between the tire surface plane and the blade plane, essentially parallel to the y-axis, is from approximately 8 inches to approximately 12 inches.

27. The method of claim 26, further comprising adjusting the lateral offset distance between the tire surface plane and the blade plane.

28. The method of claim 20, further comprising rotating the blade plane around the x-axis so as to maintain the blade plane substantially parallel to the inside face of the street curb during A1).

29. The method of claim 20, wherein:
the blade is housed in a blade housing coupled to the offset arm;
the blade housing has a bottom surface from which the blade protrudes; and
the offset arm is configured such that a bottom surface plane of the bottom surface of the blade housing, when the blade is in operation to cut the trench, is vertically offset essentially along the z-axis from the road surface.

30. The method of claim 29, wherein a vertical offset distance between the road surface and the bottom surface plane of the bottom surface of the blade housing, essentially parallel to the z-axis, is from approximately 4 inches to approximately 10 inches.

31. The method of claim 30, further comprising adjusting the vertical offset distance between the road surface and the bottom surface plane of the bottom surface of the blade housing.

32. The method of claim 29, wherein A1) comprises:
positioning the vehicle on the road surface such that at least a portion of the bottom surface of the blade housing rests on the exposed top face of the street curb.

33. The method of claim 29, wherein
the blade housing further includes an outside-facing surface and a vehicle-facing surface, wherein both the outside-facing surface and the vehicle-facing surface are substantially parallel to each other and to the blade plane; and
a lateral spacing between the blade plane and the outside-facing surface of the blade housing is from approximately 2 inches to approximately 4 inches.

34. The method of claim 29, further comprising rotating the blade housing around the y-axis so as to maintain at least a portion of the bottom surface of the blade housing in substantial contact with the exposed top surface of the street curb during A1).

35. The method of claim 1, further comprising:
B) removing from the trench debris generated during A).

36. The method of claim 35, wherein B) comprises vacuuming the debris from the trench.

37. The method of claim 35, wherein A) and B) are performed substantially contemporaneously.

38. The method of claim 1, further comprising:
C) placing in the trench at least one of fiber optic cable, electrical cable, telecommunication wire cable, and at least one conduit.

39. The method of claim 1, further comprising:
D) backfilling the trench with debris generated during A).

40. The method of claim 1, further comprising:
D) backfilling the trench with sand.

41. The method of claim 1, further comprising:
D) flowing a grout into the trench so as to partially fill the trench with the grout up to a grout level below the exposed top face of the street curb.

42. The method of claim 41, wherein a first distance between the grout level and the exposed top face of the street curb is greater than or equal to a thickness of the sidewalk material.

43. The method of claim 42, wherein the first distance is from approximately 4 inches to approximately 6 inches below the exposed top face of the street curb.

44. The method of claim 41, wherein the grout includes a non-shrinking grout.

45. The method of claim 44, wherein the grout is flowable into the trench.

46. The method of claim 44, wherein the non-shrinking grout is substantially impermeable upon drying.

47. The method of claim 41, further comprising:
E) curing the grout so as to set and rigidify the grout.

48. The method of claim 47, further comprising:
F) filling a remainder of the trench above the grout level with a mastic.

49. The method of claim 48, wherein the mastic includes an elastic compound to facilitate expansion and contraction of the sidewalk material.

50. An apparatus comprising:
a vehicle for driving on a road, the vehicle having a footprint on a road surface of the road when the vehicle is driven on the road; and
a blade mechanically coupled to the vehicle such that a blade plane of the blade is laterally offset from and is outside of the footprint of the vehicle when the vehicle is driven on the road.

51. The apparatus of claim 50, wherein the blade is configured to rotate and cut a trench on a work surface that is at the same elevation as the road surface.

52. The apparatus of claim 50, wherein the blade is configured to rotate and cut a trench on a work surface that is elevated with respect to the road surface.

53. The apparatus of claim 52, wherein the work surface comprises:
a street curb having an exposed top face elevated with respect to the road surface, a buried bottom face, a partially exposed outer face adjacent to and abutting the road surface, and an inner surface; and
a sidewalk, abutting at least a portion of the inner surface, having a top face elevated with respect to the road surface and a bottom face at a first depth from the top face,
wherein the blade is configured to cut a trench adjacent to the inner surface of the curb to a depth equal to or greater than the first depth.

54. The apparatus of claim 53, wherein the vehicle is configured to advance on the road surface substantially parallel to the outer face of the curb.

55. The apparatus of claim 50, wherein the blade is configured to cut the trench with a depth of approximately 5 inches to approximately 15 inches.

56. The apparatus of claim 50, wherein the blade is configured to cut the trench with a width of approximately 0.5 inches to approximately 1.5 inches.

57. The apparatus of claim 50, further comprising an offset arm configured to mechanically couple the blade to the vehicle.

58. The apparatus of claim 57, wherein the offset arm includes at least one non-linear portion.

59. The apparatus of claim 57, wherein the offset arm includes at least one L-shaped portion.

60. The apparatus of claim 57, wherein the offset arm includes at least one partially U-shaped portion.

61. The apparatus of claim 57, wherein one end of the offset arm is attached to the front of the vehicle.

62. The apparatus of claim 57, wherein one end of the offset arm is attached to rear of the vehicle.

63. The apparatus of claim 57, wherein one end of the offset arm is attached to the side of the vehicle.

64. The apparatus of claim 57, wherein the offset arm includes:
at least one mechanical joint;
a first offset arm portion coupled to the at least one mechanical joint; and
a second offset arm portion coupled to the at least one mechanical joint,
wherein the at least one mechanical joint provides for translation and/or rotation of the first offset arm portion relative to the second offset arm portion.

65. The apparatus of claim 64, wherein one of the first arm portion and the second arm portion is coupled to the blade, and wherein the at least one mechanical joint provides adjustment of the lateral offset of the blade plane from the vehicle footprint.

66. The apparatus of claim 65, wherein the adjustment provided is between approximately 8 inches to approximately 12 inches.

67. The apparatus of claim 64, wherein the offset arm further includes a visually readable tilt indicator for providing an indication of tilt of the blade plane.

68. The apparatus of claim 64, further comprising:
an electronic tilt sensor for outputting an electronic signal indicating a tilt of the blade plane;
a controller for receiving the electronic signal and controlling the rotation provided by the at least one mechanical joint based on the electronic signal.

69. The apparatus of claim 57, further comprising:
a blade housing partially enclosing the blade, wherein the blade housing includes a bottom surface and a bottom surface opening through which the blade protrudes,
a second joint for coupling the blade housing to the offset arm, wherein the second joint is configured to provide vertical motion to the blade housing such that the bottom surface, when the blade is in operation to cut the trench, is vertically offset from the work surface.

70. The apparatus of claim 69, wherein at least a portion of the bottom surface adjustable to maintain contact with the work surface during the operation of the blade.

71. The apparatus of claim 69, further comprising a third joint for coupling the blade housing to the offset arm, wherein the third joint is configured to rotate the blade housing around an axis that is perpendicular to the blade plane.

72. The apparatus of claim 57, further comprising
a blade housing partially enclosing the blade,
wherein the blade housing includes an inner shroud on the side of the blade facing the vehicle and an outer shroud coupled to the inner shroud disposed on the other side of the blade, wherein an outermost point on the outer shroud is no more than between approximately 2 inches to approximately 4 inches from the blade plane.

73. The apparatus of claim 69, the blade housing including an outlet near the bottom surface, the outlet configured to couple to a vacuuming system for evacuating debris produced during the operation of the blade.

74. The apparatus of claim 73, wherein the vacuuming system includes a vacuum hose coupled to the outlet on one end and coupled to a vacuuming pump at the other end.

75. The apparatus of claim 50, further comprising a curb pole attached to the offset arm, a first member of the curb pole extending out in front of the vehicle and a second member hinged to the first member extending vertically downwards towards the work surface, wherein the first member and the second member substantially coplanar with the plane of the blade.

76. An offset arm for mechanically coupling a cutting blade to a vehicle, the offset arm comprising:
a coupling mechanism to couple the offset arm to one of a front side, a rear side, and a lateral side of the vehicle; and
at least one mechanical joint to facilitate adjustment of at least one of a lateral offset distance between the vehicle and the cutting blade, a vertical offset distance between the cutting blade and a road surface, and rotation of the cutting blade around at least two axes,
wherein the offset arm is configured such that the cutting blade is laterally offset from and is outside of a footprint of the vehicle when the vehicle is driven on a road.

77. An apparatus comprising:
the offset arm of claim 76;
the cutting blade; and
a blade housing for the cutting blade, wherein the blade housing is mechanically coupled to the offset arm.

78. A system, comprising:
the apparatus of claim 77; and
the vehicle,
wherein the offset arm is coupled to the vehicle via the coupling mechanism.

79. A method for forming a trench using a cutting blade mechanically coupled to a vehicle, the method comprising:
A) advancing the vehicle such that the cutting blade traverses a surface to form a trench in the surface, wherein the cutting blade is laterally offset from and is outside of a footprint of the vehicle as the vehicle is advanced in A).

80. The method of claim 79, wherein in A), the vehicle is advanced along a road, and wherein the surface traversed by the blade is substantially coplanar with the road.

81. The method of claim 79, wherein in A), the vehicle is advanced along a road, and wherein the surface traversed by the blade is not coplanar with the road.

82. The method of claim 79, wherein the trench has a depth along a vertical dimension essentially parallel to the z-axis, extending downward from the exposed top face of the street curb, of from approximately 5 inches to approximately 15 inches.

83. The method of claim 82, wherein the depth of the trench is from approximately 10 inches to approximately 12 inches.

84. The method of claim 79, wherein the trench has a width along a lateral dimension essentially parallel to the y-axis, between the first vertical sidewall and the second vertical sidewall, of from approximately 0.5 inches to approximately 1.5 inches.
